(19) United States
(12) Patent Application Publication
(10) Pub. No.: US 2025/0205600 A1
(43) Pub. Date: Jun. 26, 2025

(54) COMPUTER-READABLE NON-TRANSITORY STORAGE MEDIUM HAVING GAME PROGRAM STORED THEREIN, GAME SYSTEM, GAME APPARATUS, AND GAME PROCESSING METHOD

(71) Applicant: Nintendo Co., Ltd., Kyoto (JP)

(72) Inventors: Makoto MIYANAGA, Kyoto (JP); Tomomi SANO, Kyoto (JP); Satoshi TERADA, Tokyo (JP); Takumi FURUYA, Tokyo (JP); Yuta OKADA, Tokyo (JP)

(21) Appl. No.: 18/799,486

(22) Filed: Aug. 9, 2024

(30) Foreign Application Priority Data
Dec. 20, 2023 (JP) 2023-215079

(51) Int. Cl. A63F 13/56; A63F 13/5252; A63F 13/533; A63F 13/69

(52) U.S. Cl. CPC A63F 13/56; A63F 13/5252; A63F 13/533; A63F 13/69

(57) ABSTRACT

A processor according to the present disclosure is configured to: control a player character in a virtual space on the basis of an operation input; automatically control a plurality of kinds of dynamic objects which are placed on a field in the virtual space, on the basis of behaviors set for the respective kinds; for imitation objects each of which an outer appearance and a set behavior are at least partially the same as and a display manner is different from at least one of the plurality of kinds of the dynamic objects, cause the player character to perform a predetermined action and cause a designated imitation object designated among a plurality of kinds of the imitation objects to appear on the field, in accordance with a first instruction based on an operation input; and automatically control the imitation object with a set behavior, on the field.

### CROSS REFERENCE TO RELATED APPLICATION

This application claims priority to Japanese Patent Application No. 2023-215079 filed on Dec. 20, 2023, the entire contents of which are incorporated herein by reference.

### FIELD

The present disclosure relates to game processing using a player character and a character for supporting the player character.

### BACKGROUND AND SUMMARY

Conventionally, there has been known a game in which a main character and a sub character having a function of supporting the main character appear.

In the above game, the main character acts on the basis of an input from a first-player operation section, and the sub character acts on the basis of an input from a second-player operation section. Thus, only one character is provided as the sub character for supporting the main character.

In this regard, there is room for providing such a game that allows a user to proceed with the game using more various characters as support characters.

Configuration examples according to the present disclosure will be shown below.

### (Configuration 1)

A configuration 1 is one or more computer-readable non-transitory storage media having stored therein a game program configured to cause a processor of an information processing apparatus to: control a player character in a virtual space on the basis of an operation input; automatically control a plurality of kinds of dynamic objects which are placed on a field in the virtual space, on the basis of behaviors set for the respective kinds; for imitation objects each of which an outer appearance and a set behavior are at least partially the same as those of at least one of the plurality of kinds of the dynamic objects and each of which a display manner is different from that of the at least one dynamic object, cause the player character to perform a predetermined action and cause a designated imitation object designated among a plurality of kinds of the imitation objects to appear on the field, in accordance with a first instruction based on an operation input; and automatically control the imitation object with a set behavior, on the field.

According to the above configuration, it is possible to proceed with the game while utilizing multiple kinds of imitation objects of which the outer appearances and the behaviors are at least partially the same as those of the dynamic objects on the field. In addition, since the display manner of the imitation object is made different from that of the dynamic object, it is possible to easily discriminate both objects even when the imitation object and the dynamic object are present at the same time.

### (Configuration 2)

In a configuration 2 based on the above configuration 1, a cost required for appearance may be set for each of the imitation objects. The game program may cause the processor to place a set cost index indicating the cost set for the imitation object, at a position in conjunction with the imitation object in the virtual space.

According to the above configuration, an index is placed as one means for making the display manner of the imitation object different. Thus, it becomes easy to recognize the imitation objects and it is possible to grasp the cost of each imitation object by the index.

### (Configuration 3)

In a configuration 3 based on the above configuration 2, a plurality of the imitation objects may be allowed to be placed on the field at the same time, as long as a total cost of the costs set for all the imitation objects on the field does not exceed an upper limit cost set for the player character. The game program may further cause the processor to: place a remaining cost index indicating a remaining cost obtained by subtracting the total cost from the upper limit cost, at a position in conjunction with the player character in the virtual space; and in a case where the designated imitation object has appeared on the field in accordance with the first instruction, move and place at least a part of the remaining cost index as the set cost index set for the designated imitation object, thus reducing the remaining cost index.

According to the above configuration, the user can easily view the remaining cost. In addition, movement representation of the index can tell the user that the imitation object will appear, in an easily understandable manner.

### (Configuration 4)

In a configuration 4 based on the above configuration 3, the game program may further cause the processor to: in a case where a second instruction based on an operation input has been performed, delete a deletion target imitation object designated among the imitation objects on the field; and move the set cost index placed in conjunction with the deletion target imitation object, so that the set cost index becomes a part of the remaining cost index, thus increasing the remaining cost index.

According to the above configuration, it is possible to arbitrarily designate and delete any of the appearing imitation objects. Therefore, the user can easily perform adjustment about which to delete and which to leave, while confirming the costs. Thus, convenience for the user can be improved.

### (Configuration 5)

In a configuration 5 based on the above configuration 4, the game program may further cause the processor to: in a case where the first instruction has been performed and the cost set for the designated imitation object exceeds the remaining cost, delete the imitation object that appeared earliest on the field and cause the designated imitation object to appear on the field.

According to the above configuration, when the user desires to cause the imitation object to appear at present, it is possible to at least cause this imitation object to appear.

### (Configuration 6)

In a configuration 6 based on the above configuration 5, the game program may further cause the processor to: in a case where the first instruction has been performed and a position on the field at which the designated imitation object is to appear is a position at which the imitation object is not allowed to be placed, perform control so as to, without deleting the imitation object on the field, display the designated imitation object for a predetermined period and then delete the designated imitation object.

According to the above configuration, the imitation object corresponding to the first instruction is momentarily displayed and then deleted immediately, for example, whereby the user can visually recognize that the position is a position where the imitation object cannot appear.

### (Configuration 7)

In a configuration 7 based on any of the above configurations 1 to 6, the game program may further cause the processor to: present a first list that allows selection from the plurality of kinds of imitation objects in accordance with a third instruction based on an operation input; while the first list is being presented, stop behaviors of objects in the virtual space including at least the player character, the dynamic objects, and the imitation objects; and in accordance with a fourth instruction based on an operation input performed while the first list is being presented, select and designate any of the plurality of kinds of imitation objects as the designated imitation object, end presentation of the first list, and restart the behaviors of the objects in the virtual space.

According to the above configuration, it is possible to quickly cause one imitation object to appear only by the first instruction, without stopping game progress. On the other hand, while the imitation object to appear is being selected by the user, game progress is stopped. Thus, the user can deeply think about which to use in accordance with the situation, in contrast to a case of selectively using any of a plurality of imitation objects in real time by a plurality of instruction operations.

### (Configuration 8)

In a configuration 8 based on the above configuration 7, the third instruction may be an operation of turning on an input to a first operation key, and the fourth instruction may be an operation of turning off the input to the first operation key. The game program may cause the processor to: while the input to the first operation key is on, present the first list, and change the imitation object to be selected on the first list, in accordance with a fifth instruction based on an operation input; and designate the imitation object selected when the fourth instruction has been performed, as the designated imitation object.

According to the above configuration, it is possible to both close the first list and designate an imitation object, by canceling the operation key input. Thus, the user can quickly select an imitation object with reduced effort of operation. In addition, an operation configuration suitable to a case of using an imitation object while switching among various imitation objects, can be provided.

### (Configuration 9)

In a configuration 9 based on the above configuration 8, the game program may further cause the processor to: while the first list is being presented, in a case where a sixth instruction based on an operation input has been performed, present a second list instead of the first list; and while the second list is being presented, in accordance with a seventh instruction based on an operation input, change the imitation object to be selected on the second list, and in accordance with an eighth instruction based on an operation input, designate the selected imitation object as the designated imitation object and end presentation of the second list. The first list may be a list in which icons of the plurality of kinds of imitation objects are arranged in one row, and the second list may be a list in which icons of the plurality of kinds of imitation objects are arranged two-dimensionally and with which a text regarding the selected imitation object is displayed.

According to the above configuration, in a situation in which it is difficult to quickly select an imitation object, the user can change the screen to a screen shown in a list form with explanation and then can select an imitation object deliberately.

### (Configuration 10)

In a configuration 10 based on any one of the above configurations 1 to 9, the game program may further cause the processor to: shift the player character into a first mode in accordance with a ninth instruction based on an operation input; and in the first mode, cause the player character to perform an attack action instead of causing the imitation object to appear, in accordance with the first instruction, automatically control the imitation object placed on the field, with the set behavior, and cancel the first mode in accordance with a tenth instruction based on an operation input.

According to the above configuration, it is possible to increase variations of actions that the user can take, while avoiding occurrence of such a situation that the number of targets to be operated at the same time is increased and thus user's operations are complicated, for example. In addition, it is also possible to perform an attack action together with an imitation object, depending on the scene. Thus, for example, the user can consider such a scene that the player character should be shifted into the first mode, whereby strategy of the game is improved and such a way of play that the user enjoys switchover to the first mode can be provided.

### (Configuration 11)

In a configuration 11 based on the above configuration 10, the game program may further cause the processor to: in the first mode, change a first parameter as time elapses, and in a case where the first parameter satisfies a predetermined condition, cancel the first mode.

According to the above configuration, a time limit can be set for the first mode, whereby a sense of tension is provided in the game and amusement of the game can be improved. In addition, such a game element that change of the first parameter is managed is provided, whereby amusement of the game can be improved.

### (Configuration 12)

In a configuration 12 based on any one of the above configurations 1 to 11, the game program may further cause the processor to: in a case where the player character has performed a predetermined action to the dynamic object on the field, add the imitation object of a kind corresponding to the dynamic object, to the plurality of kinds of the imitation objects.

According to the above configuration, by the player character performing a predetermined action for a dynamic object, the imitation object corresponding to the dynamic object can be made available. Thus, for example, as compared to a case of making an imitation object available through a predetermined event such as completion of a quest, the number of locations or occasions where imitation objects are made available is not limited to one, so that the degree of freedom in playing through the game can be enhanced. Meanwhile, the user can begin to utilize an imitation object corresponding to each dynamic object after at least seeing the behavior of the dynamic object on the field. For example, in a case where the dynamic object is an enemy character, the user confirms the behavior thereof such as an attack method and then can utilize the imitation object corresponding to the enemy character. Thus, through a battle against an enemy character, the user can grasp the behavior of the corresponding imitation character in advance.

### (Configuration 13)

In a configuration 13 based on any one of the above configurations 1 to 12, the field may include at least a top view field which is a field where a virtual camera is set on a top view, and a side view field which is a field where a virtual camera is set on a side view. Behaviors set for the dynamic objects and the imitation objects may be behaviors in the top view field and the side view field.

According to the above configuration, in such a game that uses a top view field and a side view field, the same sense of operation and the same game characteristics can be provided with respect to imitation objects.

According to the exemplary embodiment, it is possible to provide such a game that allows a user to proceed with the game using multiple kinds of imitation objects of which the outer appearances and the behaviors are equivalent to those of dynamic objects on a field.

### BRIEF DESCRIPTION OF THE DRAWINGS

FIG. 1 shows a non-limiting example of a state in which a left controller 3 and a right controller 4 are attached to a main body apparatus 2;

FIG. 2 shows a non-limiting example of a state in which the left controller 3 and the right controller 4 are detached from the main body apparatus 2;

FIG. 3 is six orthogonal views showing a non-limiting example of the main body apparatus 2;

FIG. 4 is six orthogonal views showing a non-limiting example of the left controller 3;

FIG. 5 is six orthogonal views showing a non-limiting example of the right controller 4;

FIG. 6 is a block diagram showing a non-limiting example of the internal configuration of the main body apparatus 2;

FIG. 7 is a block diagram showing a non-limiting example of the internal configurations of the main body apparatus 2, the left controller 3, and the right controller 4;

FIG. 8 shows a non-limiting example of a game image according to an exemplary embodiment;

FIG. 9 is an enlarged view showing a non-limiting example of a PC 201 and the like;

FIG. 10 shows a non-limiting example of a game image according to the exemplary embodiment;

FIG. 11 illustrates a non-limiting example of difference in display manners;

FIG. 12 illustrates a non-limiting example of difference in display manners;

FIG. 13 shows a non-limiting example of a game image (first action) according to the exemplary embodiment;

FIG. 14 shows a non-limiting example of a game image (first action) according to the exemplary embodiment;

FIG. 15 shows a non-limiting example of a game image (first action) according to the exemplary embodiment;

FIG. 16 shows a non-limiting example of a game image (first action) according to the exemplary embodiment;

FIG. 17 shows a non-limiting example of a game image (first action) according to the exemplary embodiment;

FIG. 18 shows a non-limiting example of a game image (first action) according to the exemplary embodiment;

FIG. 19 shows a non-limiting example of a game image (second action) according to the exemplary embodiment;

FIG. 20 shows a non-limiting example of a game image (second action) according to the exemplary embodiment;

FIG. 21 shows a non-limiting example of a game image (second action) according to the exemplary embodiment;

FIG. 22 shows a non-limiting example of a game image (second action) according to the exemplary embodiment;

FIG. 23 shows a non-limiting example of a game image (second action) according to the exemplary embodiment;

FIG. 24 shows a non-limiting example of a game image (second action) according to the exemplary embodiment;

FIG. 25 shows a non-limiting example of a game image (deletion operation) according to the exemplary embodiment;

FIG. 26 shows a non-limiting example of a game image (deletion operation) according to the exemplary embodiment;

FIG. 27 shows a non-limiting example of a game image (quick list) according to the exemplary embodiment;

FIG. 28 shows a non-limiting example of a game image (picture book) according to the exemplary embodiment;

FIG. 29 shows a non-limiting example of a game image (transformation mode) according to the exemplary embodiment;

FIG. 30 shows a non-limiting example of a game image (transformation mode) according to the exemplary embodiment;

FIG. 31 is a memory map showing a non-limiting example of various data stored in a DRAM 85;

FIG. 32 shows a non-limiting example of PC data 302;

FIG. 33 shows a non-limiting example of index data 304;

FIG. 34 shows a non-limiting example of a dynamic object master 305;

FIG. 35 shows a non-limiting example of field object data 306;

FIG. 36 shows a non-limiting example of an imitation object master 307;

FIG. 37 shows a non-limiting example of appearing object data 308;

FIG. 38 shows a non-limiting example of operation data 309;

FIG. 39 is a non-limiting example of a flowchart showing the details of game processing according to the exemplary embodiment;

FIG. 40 is a non-limiting example of a flowchart showing the details of a field play process;

FIG. 41 is a non-limiting example of a flowchart showing the details of a PC control process;

FIG. 42 is a non-limiting example of a flowchart showing the details of a normal mode process;

FIG. 43 is a non-limiting example of a flowchart showing the details of a PC movement control process;

FIG. 44 is a non-limiting example of a flowchart showing the details of a first action control process;

FIG. 45 is a non-limiting example of a flowchart showing the details of a second action control process;

FIG. 46 is a non-limiting example of a flowchart showing the details of the second action control process;

FIG. 47 is a non-limiting example of a flowchart showing the details of a deletion instruction process;

FIG. 48 is a non-limiting example of a flowchart showing the details of the deletion instruction process;

FIG. 49 is a non-limiting example of a flowchart showing the details of a transformation control process;

FIG. 50 is a non-limiting example of a flowchart showing the details of a quick designation control process;

FIG. 51 is a non-limiting example of a flowchart showing the details of a pause control process;

FIG. 52 is a non-limiting example of a flowchart showing the details of a transformation mode process;

FIG. 53 is a non-limiting example of a flowchart showing the details of an attack action process;

FIG. 54 is a non-limiting example of a flowchart showing the details of an AO control process;

FIG. 55 is a non-limiting example of a flowchart showing the details of a deletion representation control process;

FIG. 56 is a non-limiting example of a flowchart showing the details of an appearing representation control process;

FIG. 57 is a non-limiting example of a flowchart showing the details of an appearance-impossibility representation control process;

FIG. 58 is a non-limiting example of a flowchart showing the details of a relevant game process;

FIG. 59 is a non-limiting example of a flowchart showing the details of the relevant game process;

FIG. 60 is a non-limiting example of a flowchart showing the details of a quick list process;

FIG. 61 is a non-limiting example of a flowchart showing the details of the quick list process;

FIG. 62 is a non-limiting example of a flowchart showing the details of a picture book process; and

FIG. 63 is a non-limiting example of a flowchart showing the details of the picture book process.

### DETAILED DESCRIPTION OF NON-LIMITING EXAMPLE EMBODIMENTS

Hereinafter, an exemplary embodiment will be described.

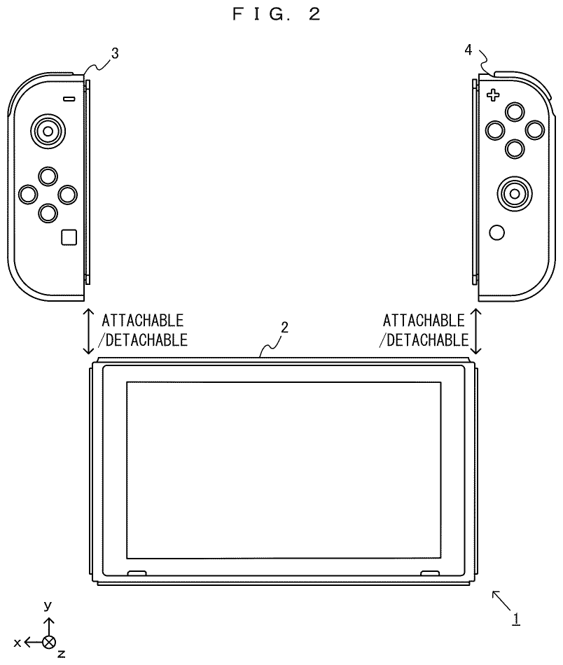

A game system according to an example of the exemplary embodiment will be described below. An example of a game system 1 according to the exemplary embodiment includes a main body apparatus (an information processing apparatus, which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment will be described, and then, the control of the game system 1 according to the exemplary embodiment will be described.

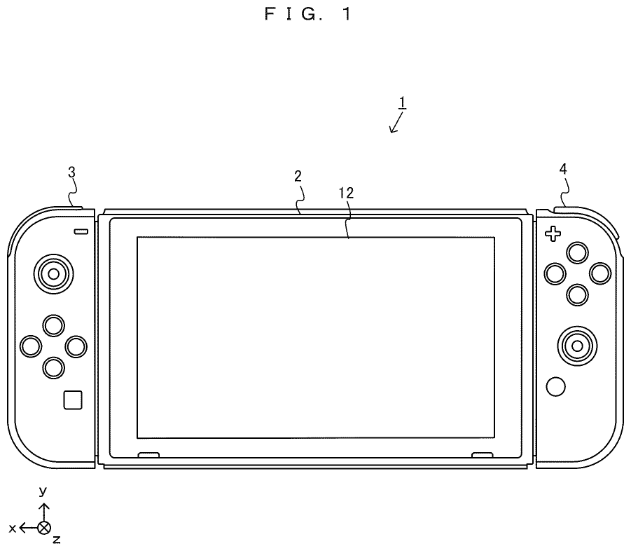

FIG. 1 shows an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a player provides inputs.

FIG. 2 shows an example of the state where each of the left controller 3 and the right controller 4 is detached from the main body apparatus 2. As shown in FIGS. 1 and 2, the left controller 3 and the right controller 4 are attachable to and detachable from the main body apparatus 2. Hereinafter, the left controller 3 and the right controller 4 may be collectively referred to as “controller”

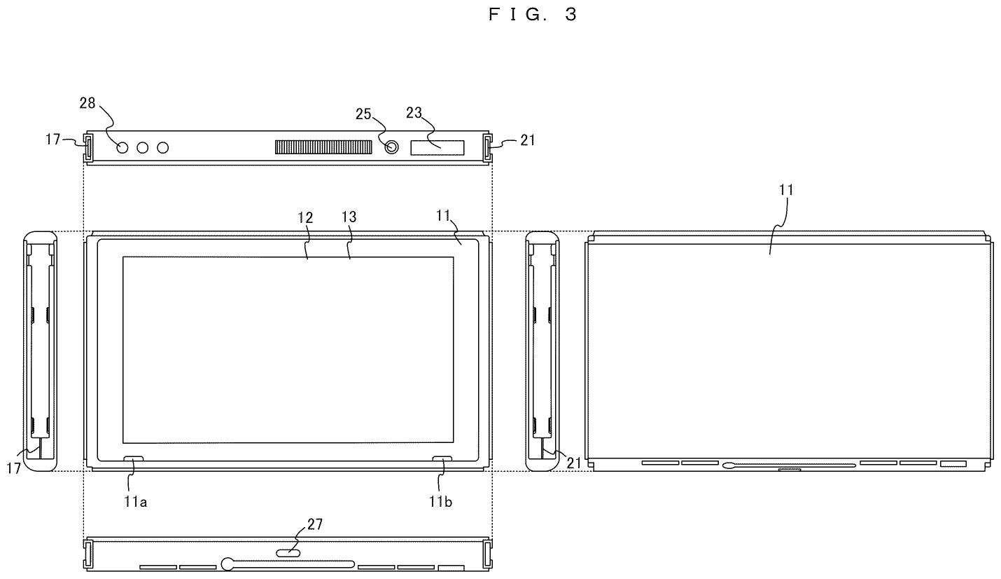

FIG. 3 is six orthogonal views showing an example of the main body apparatus 2. As shown in FIG. 3, the main body apparatus 2 includes an approximately plate-shaped housing 11. In the exemplary embodiment, a main surface (in other words, a surface on a front side, i.e., a surface on which the display 12 is provided) of the housing 11 has a substantially rectangular shape.

The shape and the size of the housing 11 are discretionary. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

The main body apparatus 2 includes a touch panel 13 on the screen of the display 12. In the exemplary embodiment, the touch panel 13 is of a type capable of receiving a multi-touch input (e.g., electrical capacitance type). However, the touch panel 13 may be of any type, and may be, for example, of a type capable of receiving a single-touch input (e.g., resistive film type).

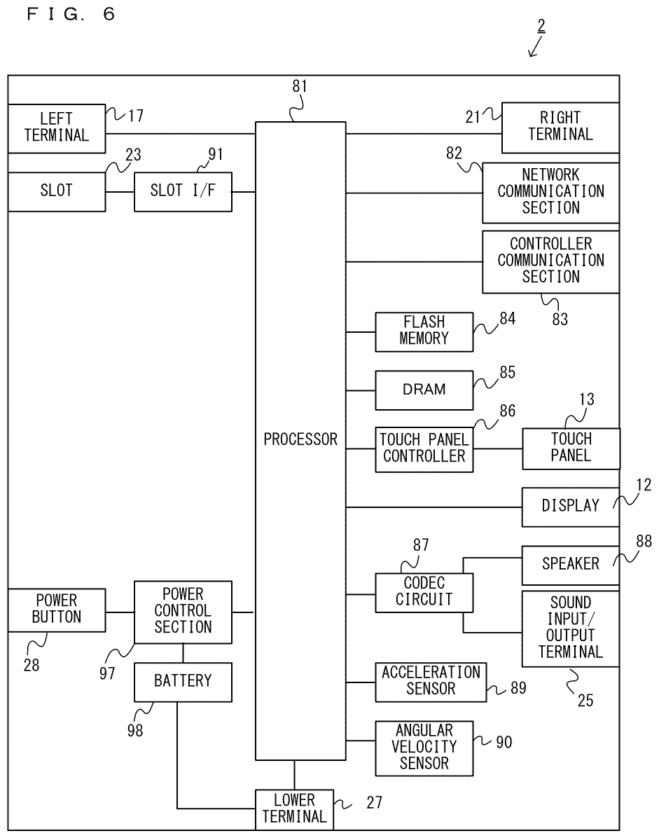

The main body apparatus 2 includes speakers (i.e., speakers 88 shown in FIG. 6) within the housing 11. As shown in FIG. 3, speaker holes 11a and 11b are formed in the main surface of the housing 11. Then, sounds outputted from the speakers 88 are outputted through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided at an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a stationary monitor an image generated by and outputted from the main body apparatus 2. Further, in the exemplary embodiment, the cradle has the function of charging the unified apparatus or the main body apparatus 2 alone mounted on the cradle. Further, the cradle has the function of a hub device (specifically, a USB hub).

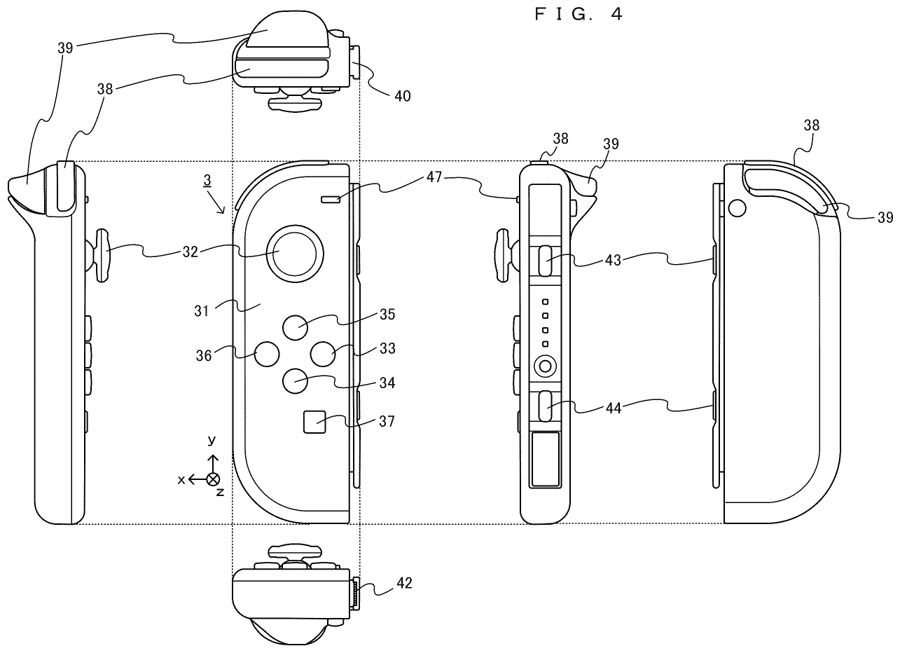

FIG. 4 is six orthogonal views showing an example of the left controller 3. As shown in FIG. 4, the left controller 3 includes a housing 31. In the exemplary embodiment, the housing 31 has a vertically long shape, i.e., is shaped to be long in an up-down direction shown in FIG. 4 (i.e., a z-axis direction shown in FIG. 4). In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly, the left hand. Further, the left controller 3 can also be held in the orientation in which the left controller 3 is horizontally long. When held in the orientation in which the left controller 3 is horizontally long, the left controller 3 may be held with both hands.

The left controller 3 includes a left analog stick (hereinafter, referred to as a “left stick”) 32 as an example of a direction input device. As shown in FIG. 4, the left stick 32 is provided on a main surface of the housing 31. The left stick 32 can be used as a direction input section with which a direction can be inputted. The player tilts the left stick 32 and thereby can input a direction corresponding to the direction of the tilt (and input a magnitude corresponding to the angle of the tilt). The left controller 3 may include a directional pad, a slide stick that allows a slide input, or the like as the direction input section, instead of the analog stick. Further, in the exemplary embodiment, it is possible to provide an input by pressing the left stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an OS program and an application program) executed by the main body apparatus 2.

Further, the left controller 3 includes a terminal 42 for the left controller 3 to perform wired communication with the main body apparatus 2.

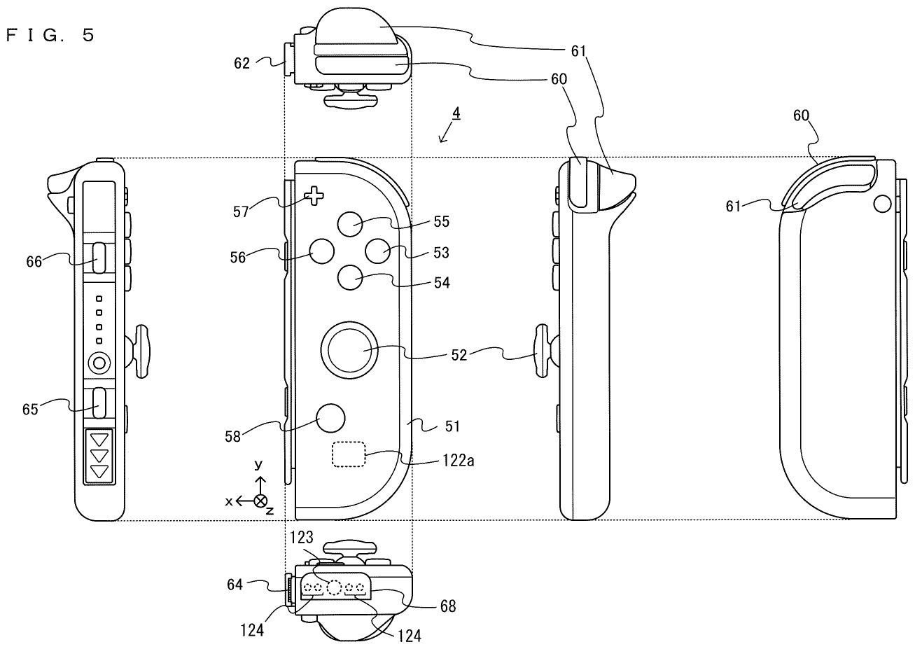

FIG. 5 is six orthogonal views showing an example of the right controller 4. As shown in FIG. 5, the right controller 4 includes a housing 51. In the exemplary embodiment, the housing 51 has a vertically long shape, i.e., is shaped to be long in the up-down direction shown in FIG. 5 (i.e., the z-axis direction shown in FIG. 5). In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes a right analog stick (hereinafter, referred to as a “right stick”) 52 as a direction input section. In the exemplary embodiment, the right stick 52 has the same configuration as that of the left stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 91, 97, and 98 shown in FIG. 6 in addition to the components shown in FIG. 3. Some of the components 81 to 91, 97, and 98 may be mounted as electronic components on an electronic circuit board and housed in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes the flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing.

The main body apparatus 2 includes a slot interface (hereinafter, abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined method for communication (e.g., communication based on a unique protocol or infrared light communication). The wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2, and the left controller 3 and the right controller 4, is discretionary. In the exemplary embodiment, the controller communication section 83 performs communication compliant with the Bluetooth (registered trademark) standard with the left controller 3 and with the right controller 4. The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of players can simultaneously provide inputs to the main body apparatus 2, each using a set of the left controller 3 and the right controller 4. As an example, a first player can provide an input to the main body apparatus 2 using a first set of the left controller 3 and the right controller 4, and simultaneously, a second player can provide an input to the main body apparatus 2 using a second set of the left controller 3 and the right controller 4.

The main body apparatus 2 includes a touch panel controller 86, which is a circuit for controlling the touch panel 13. The touch panel controller 86 is connected between the touch panel 13 and the processor 81. On the basis of a signal from the touch panel 13, the touch panel controller 86 generates data indicating the position at which a touch input has been performed, for example, and outputs the data to the processor 81.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). On the basis of a command from the processor 81, the power control section 97 controls the supply of power from the battery 98 to the above components.

Further, the battery 98 is connected to the lower terminal 27. When an external charging device (e.g., the cradle) is connected to the lower terminal 27 and power is supplied to the main body apparatus 2 via the lower terminal 27, the battery 98 is charged with the supplied power.

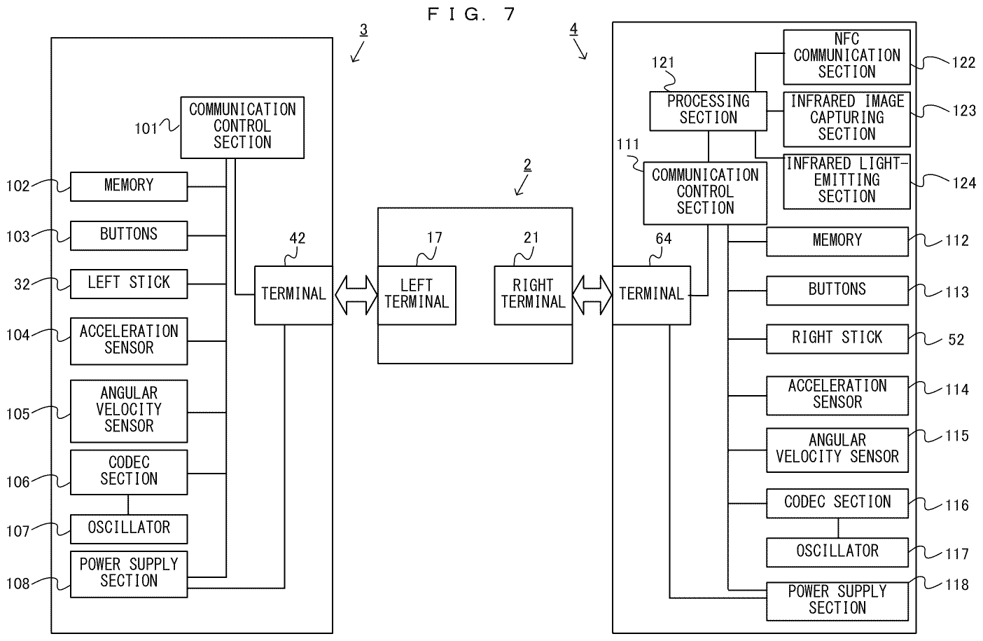

FIG. 7 is a block diagram showing examples of the internal configurations of the main body apparatus 2, the left controller 3, and the right controller 4. The details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the left stick 32. Each of the buttons 103 and the left stick 32 outputs information regarding an operation performed on itself to the communication control section 101 repeatedly at appropriate timings.

The left controller 3 includes inertial sensors. Specifically, the left controller 3 includes an acceleration sensor 104. Further, the left controller 3 includes an angular velocity sensor 105. In the exemplary embodiment, the acceleration sensor 104 detects the magnitudes of accelerations along predetermined three axial (e.g., x, y, z axes shown in FIG. 4) directions. The acceleration sensor 104 may detect an acceleration along one axial direction or accelerations along two axial directions. In the exemplary embodiment, the angular velocity sensor 105 detects angular velocities about predetermined three axes (e.g., the x, y, z axes shown in FIG. 4). The angular velocity sensor 105 may detect an angular velocity about one axis or angular velocities about two axes. Each of the acceleration sensor 104 and the angular velocity sensor 105 is connected to the communication control section 101. Then, the detection results of the acceleration sensor 104 and the angular velocity sensor 105 are outputted to the communication control section 101 repeatedly at appropriate timings.

The communication control section 101 acquires information regarding an input (specifically, information regarding an operation or the detection result of the sensor) from each of input sections (specifically, the buttons 103, the left stick 32, and the sensors 104 and 105). The communication control section 101 transmits operation data including the acquired information (or information obtained by performing predetermined processing on the acquired information) to the main body apparatus 2. The operation data is transmitted repeatedly, once every predetermined time. The interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the left stick 32 on the basis of the operation data. Further, the main body apparatus 2 can calculate information regarding the motion and/or the orientation of the left controller 3 on the basis of the operation data (specifically, the detection results of the acceleration sensor 104 and the angular velocity sensor 105).

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, the right stick 52, and inertial sensors (an acceleration sensor 114 and an angular velocity sensor 115). These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### Outline of Game Processing in Exemplary Embodiment

Next, the outline of operation of the game processing executed by the game system 1 (hereinafter, may be referred to as “game apparatus 1”) according to the exemplary embodiment will be described. As described above, in the game system 1, the main body apparatus 2 is configured such that each of the left controller 3 and the right controller 4 is attachable thereto and detachable therefrom. In a case of playing the game with the left controller 3 and the right controller 4 attached to the main body apparatus 2, a game image is outputted to the display 12. In a case where the main body apparatus 2 alone with the left controller 3 and the right controller 4 detached therefrom is mounted on the cradle, the main body apparatus 2 can output a game image to a stationary monitor or the like via the cradle. In the exemplary embodiment, the case of playing the game in the latter manner will be described as an example. Specifically, the main body apparatus 2 alone with the left controller 3 and the right controller 4 detached therefrom is mounted on the cradle, and the main body apparatus 2 outputs a game image and the like to a stationary monitor or the like via the cradle.

### [Assumed Game]

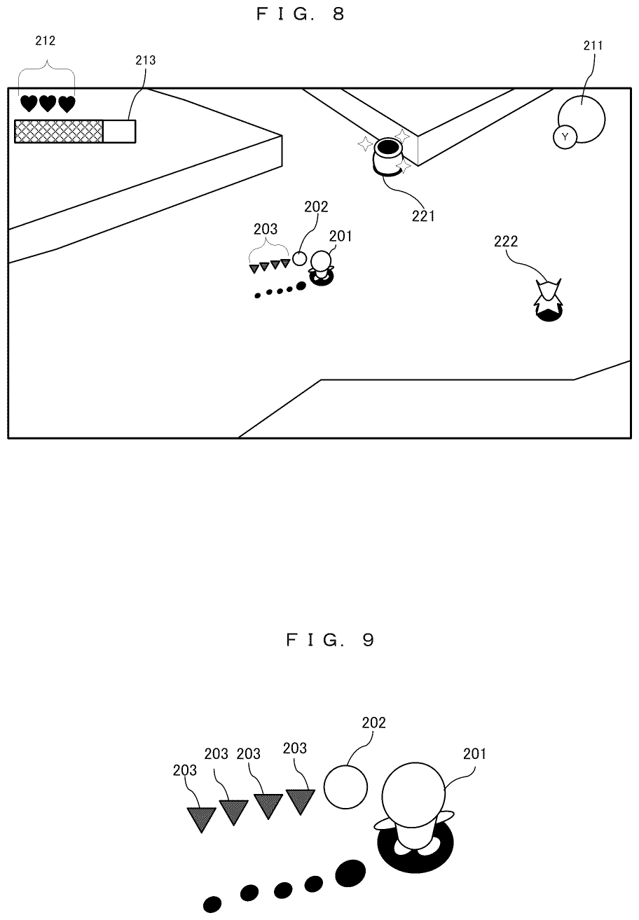

Next, the outline of a game assumed in the exemplary embodiment will be described. The game assumed in the exemplary embodiment is an action RPG, for example. FIG. 8 shows an example of a game image of this game. The game image shown in FIG. 8 is drawn from such a viewpoint as to look down on a field in a virtual game space (hereinafter, virtual space) from above. Hereinafter, a game image based on a viewpoint from above is referred to as a top view image. In a case of FIG. 8, such a view as to look down obliquely is shown. This view is also based on such a viewpoint as to look down from above and thus is regarded as a top view. In another exemplary embodiment, the top view image may be an image as seen from directly above. In another exemplary embodiment, an isometric view may be adopted. In this game, a player character (hereinafter, referred to as PC) which is a target to be operated by a user is operated in the virtual space, thus proceeding with the game. Meanwhile, the user utilizes “imitation objects” described later, to overcome various gimmicks in the game or attack an enemy character, for example, thus proceeding with the game.

In FIG. 8, a PC 201 is displayed substantially at the center of the screen. Near the PC 201, a support character object (hereinafter, referred to as support character) 202 and a plurality of index objects (hereinafter, referred to as indices) 203 are also displayed. FIG. 9 shows an enlarged view of the PC 201, the support character 202, and the indices 203. The support character 202 is a character object that is smaller than the PC 201 and is floating around an area above the head or the shoulder of the PC, for example. Each index 203 is an object having an inverted triangular shape. The index 203 is floating at a height approximately equal to the height of the support character 202. The support character 202 is subjected to movement control so as to follow the PC 201. Basically, the index 203 is subjected to movement control so as to follow the support character 202. That is, the support character 202 and the index 203 are controlled so as to follow movement of the PC 201. The details of the index 203 will be described later.

Returning to FIG. 8, a designation box 211 is displayed near the upper right corner of the game image. In addition, a health mark 212 and a transformation gauge 213 are displayed near the upper left corner. The health mark 212 indicates the health of the PC 201. The transformation gauge 213 will be described later.

### [Dynamic Object]

In FIG. 8, a pot-shaped object 221 (hereinafter, referred to as pot) and an enemy character object (hereinafter, referred to as enemy character) 222 are displayed on the field. In FIG. 8, an effect of glittering (hereinafter, referred to as glittering effect) is also displayed around the pot 221, and this will be described later.

Here, in the exemplary embodiment, among objects in the virtual space, a plurality of kinds of predetermined objects which can be placed in the field and which are virtual objects other than static objects such as terrain objects and the PC 201 which is a target to be operated by the player, the support character 202, and the index 203, are collectively referred to as “dynamic objects”. Therefore, the pot 221 and the enemy character 222 are kinds of dynamic objects. That is, the pot 221 is a dynamic object whose kind is “pot”. The enemy character 222 is a dynamic object whose kind is “enemy character”. More specifically, the kinds of “enemy characters” are further classified into “enemy A”, “enemy B”, and “enemy C”, for example, and the enemy character 222 in FIG. 8 is a dynamic object whose kind is “enemy A”, for example.

In the exemplary embodiment, the dynamic object is controlled so as to perform a predetermined behavior on the basis of behavior data set in advance for each kind. Here, the “behavior” includes not only such a behavior that a dynamic object acts autonomously and voluntarily but also a reactive behavior. That is, making a certain reaction in response to a predetermined action performed by the PC 201 is also included as a behavior. For example, in a case of the pot 221, the pot 221 performs a behavior of “being lifted” in response to the PC 201 having performed an action of lifting. Examples of behaviors of the enemy character 222 include a behavior of moving in a predetermined range in the virtual space and a behavior of performing an attack action to the PC 201 when the PC 201 comes close to the enemy character 222 to a certain extent.

Other examples of the dynamic object include a rock, a box, a table, a bed, and a trampoline.

### [Viewpoint of Game Image]

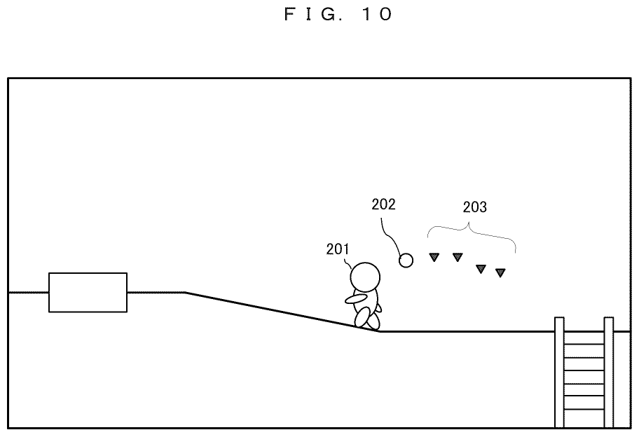

Here, supplementary explanation will be given about a viewpoint (the position of a virtual camera) for drawing a game image in this game. This game includes a game scene in which a field is displayed by a top view image as described above, and in addition, a game scene in which a field is displayed by a so-called side view image. For example, in a case where the PC 201 enters an “entrance of a cave” displayed on a field (top view field) in a top view image, a game image in the cave is displayed as a game image of a field on a side view (side view field) as shown in FIG. 10. That is, a game image when the PC 201 is seen from a viewpoint in the horizontal direction is drawn. Thus, in this game, the game image is switched between a top view image and a side view image in accordance with the scene of the game. It is noted that, while the viewpoint of the virtual camera is different, various objects such as the PC 201 and dynamic objects are subjected to equivalent controls between different viewpoint cases. In the following description, a scene of a top view image is assumed, but various processes described below are also applied to a scene of a side view image in the same manner. Hereinafter, irrespective of whether on a top view or a side view, screens on which a game field as described above is displayed and the user can operate the PC 201 are collectively referred to as “field screens”.

[Actions that PC can Perform]

Next, things (action examples) that the PC 201 can do in the game space, and operation examples that the user can perform, will be described. In this game, the user can cause the PC 201 to perform two kinds of actions, i.e., an action for making an imitation object (described later) available (hereinafter, “first action”), and an action for causing the imitation object to appear on the field (hereinafter, “second action”). The first action is an action that, when being performed for a predetermined dynamic object, can make an “imitation object” corresponding to the dynamic object into an available state. As it were, this is an action for changing an imitation object from an “unavailable” state to an “available” state. Hereinafter, an operation for causing the PC 201 to perform the first action is referred to as a “make-available operation “, and an operation for causing the PC 201 to perform the second action is referred to as an “appearance instruction operation”.

### [Imitation Object]

Here, the “imitation object” will be described. To put it simply, the imitation object is an object that “imitates (in a different display manner)” each kind of the dynamic objects. Specifically, the imitation object is an object of which the outer appearance and the behavior content are at least partially the same as the outer appearance of each kind of the dynamic objects and a behavior content set for each kind of the dynamic objects, and of which the display manner is different from that of the corresponding dynamic object. In a case where the imitation object is an object that can autonomously act, the imitation object is controlled in a position in favor of the PC 201. For example, an imitation object corresponding to the enemy character 222 is treated in a position in favor of the PC 201, and is controlled with a behavior of performing an attack action to the enemy character 222.

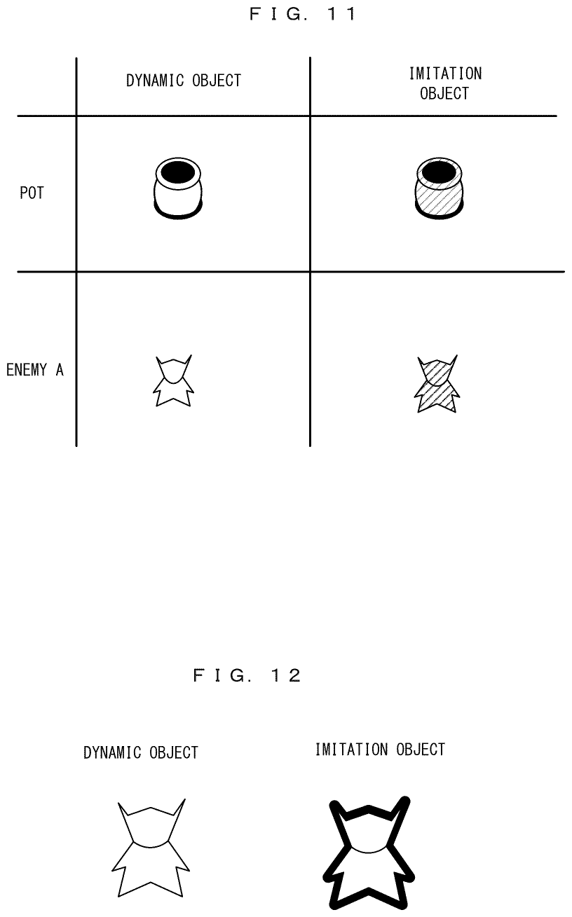

FIG. 11 shows an example of difference in display manners of a dynamic object and an imitation object. In FIG. 11, for example, in a case of the pot 221, an imitation object (hereinafter, may be referred to as an imitation pot) corresponding to the pot 221 has the same shape as the pot 221 but has a surface color different from that of the pot 221. Similarly, an imitation object (hereinafter, may be referred to as imitation enemy) corresponding to the enemy character 222 (enemy A) has the same shape but has a different surface color, so that the display manner is changed. As a method for changing the color, a predetermined texture may be applied to the same model as a dynamic object, in addition to or instead of an original texture, to perform drawing, or drawing may be performed with the color corrected by a predetermined method. A method for changing the display manner is not limited to the method of changing the surface color as described above. For example, as shown in FIG. 12, a predetermined image effect may be imparted along the outline of the shape of an imitation character. Alternatively, a display manner different from that of the dynamic character may be realized by blinking an imitation character or by displaying an imitation character translucently. As described above, an imitation object may be an object of which the outer appearance is partially the same as that of a dynamic character. Although described later in detail, in this game, the index 203 is placed at a position above the imitation object. The placed index 203 is controlled so as to follow movement of the imitation object. In other words, the placed index 203 is controlled in conjunction with the imitation object. Since the index 203 is not placed for a dynamic object, it can be said that placing the index 203 makes the display manner of the imitation object different from that of the dynamic object. A plurality of methods among the above methods and other methods may be combined to realize a different display manner.

The behavior of an imitation character is at least partially the same as the behavior of a dynamic character as described above. In other words, an imitation character may perform such a behavior that is not performed by a corresponding dynamic character. For example, in a case of the enemy character 222, the enemy character 222 as a dynamic object performs an attack action to the PC 201 as an attack target, whereas in a case of an imitation enemy, the imitation enemy performs an attack action to the enemy character 222 as an attack target, which is in a relationship that opposes the PC 201, as described above. Thus, such a behavior that an imitation enemy attacks the enemy character 222 can also occur. In this case, the content of the “attack action” is the same between both behaviors. For example, attack methods (e.g., a weapon, an action, and the like to be used) are controlled to be the same between the enemy character 222 and the imitation enemy. Regarding movement control, the enemy character 222 is controlled to move around an initial placement position on the field, whereas an imitation enemy is controlled to move while following the PC 201. It is noted that movement methods (e.g., run, walk, or fly) are controlled to be the same between the enemy character 222 and the imitation enemy. Thus, while an imitation object has a behavior that is at least partially the same as a corresponding dynamic object, the imitation object can also perform a behavior different from that of the dynamic object.

### [First Action]

Returning to explanation of operation of the PC 201, as described above, by performing the “first action” to a predetermined dynamic object, an imitation object corresponding to the kind of the dynamic object becomes available. Here, a dynamic object to which the “first action” can be performed is, in other words, a dynamic object for which an imitation object has not become available yet. In the exemplary embodiment, such a dynamic object to which the “first action” can be performed is imparted with a predetermined image effect indicating that fact. In this example, a “glittering effect” as shown in FIG. 8 is imparted. For a dynamic object of a kind for which an imitation object has been made available once, a glittering effect will not be displayed after that. That is, it suffices that the first action is performed to each kind of dynamic object only once for the first time, and it is not necessary to perform the first action multiple times to the same kind of dynamic object. As described above, in a case where an imitation object corresponding to a dynamic object is allowed to be used after the first action is performed, a quest element can be provided in the game, in contrast to a case where an imitation object can be used from the start. When there are dynamic objects of the same kind, it suffices that the first action is performed for any of the dynamic objects, and thus a quest element with a high degree of freedom can be provided.

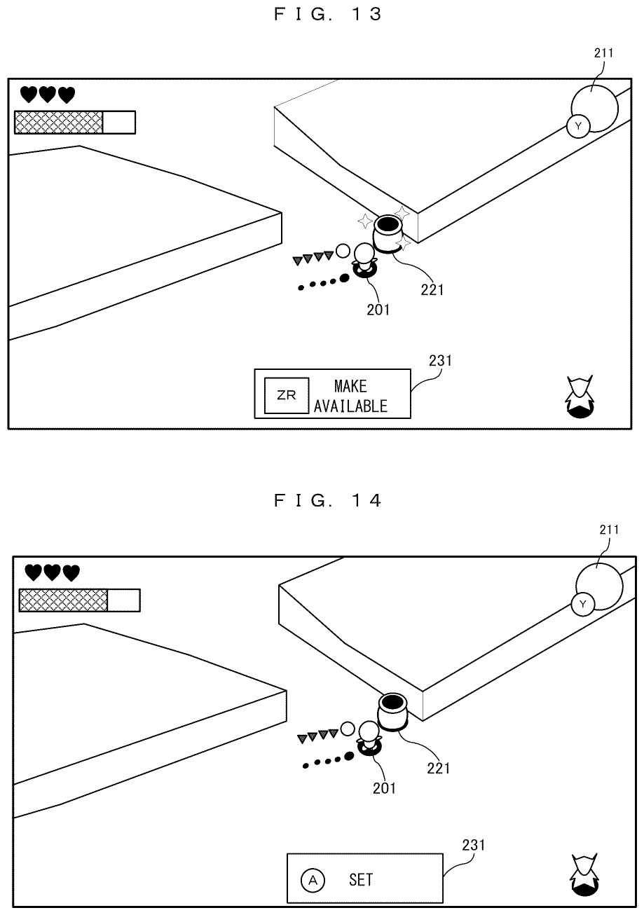

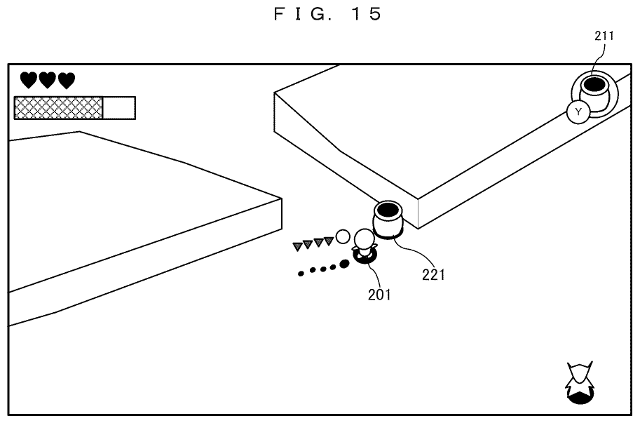

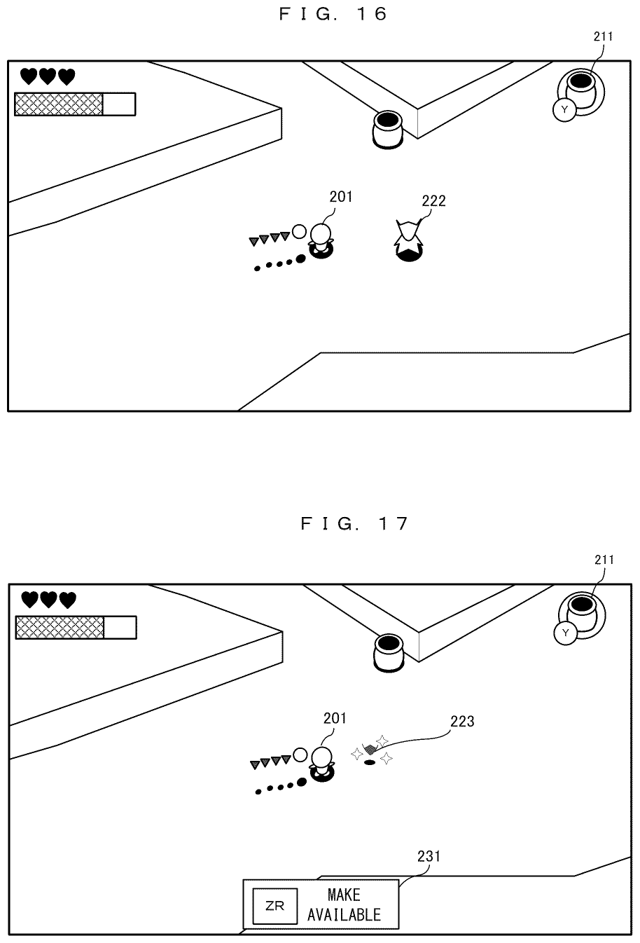

Next, operation examples and screen examples relevant to the first action will be described with reference to FIG. 13 to FIG. 18. Here, a case of performing the first action to the pot 221 will be described as an example. From the state in FIG. 8, when the PC 201 is moved close to the pot 221, the screen comes into a state shown in FIG. 13. In FIG. 13, a guide image 231 is displayed on a lower side of the screen. The guide image 231 is an image indicating an operation guide for executing the first action and indicating that performing an operation for the first action will make a predetermined imitation object available. In the example in FIG. 13, it is indicated that the user can cause the PC 201 to perform the first action by pressing the ZR-button 61. Hereinafter, the guide image 231 as shown in FIG. 13 is referred to as a “ZR guide”. In the state as shown in FIG. 13, when the user presses the ZR-button 61, the PC 201 makes a predetermined motion (not shown) corresponding to the first action, and a predetermined representation (not shown) indicating that an imitation object (imitation pot) corresponding to the pot 221 has become available is displayed. After the first action, as shown in FIG. 14, the glittering effect that has been displayed at the pot 221 is no longer displayed. As the first action is finished, the display content of the guide image 231 is changed as shown in FIG. 14. Specifically, the guide image 231 is displayed as an image for suggesting that an imitation object that has been made available this time (in the example in FIG. 14, the imitation pot) is to be “set” in the designation box 211 displayed at the upper right of the screen. Hereinafter, the guide image 231 as shown in FIG. 14 is referred to as a “quick designation guide”. In the example in FIG. 14, it is indicated that the user can “set” the imitation pot in the designation box 211 by pressing the A button 53. The quick designation guide may be deleted when a predetermined period has elapsed. The imitation pot is set in the designation box 211 by the user pressing the A button 53 while the quick designation guide is being displayed. Specifically, as shown in FIG. 15, an image indicating the imitation pot is displayed in the designation box 211. Along with this, the guide image 231 is deleted. Then, in a state in which an image of any imitation object is displayed in the designation box 211, by causing the PC 201 to perform the “second action” described later, the imitation object set in the designation box 211 can be caused to appear on the field. In other words, the designation box 211 indicates which imitation object can be caused to appear on the field by the “second action”.

### [“First Action” to Enemy Character]

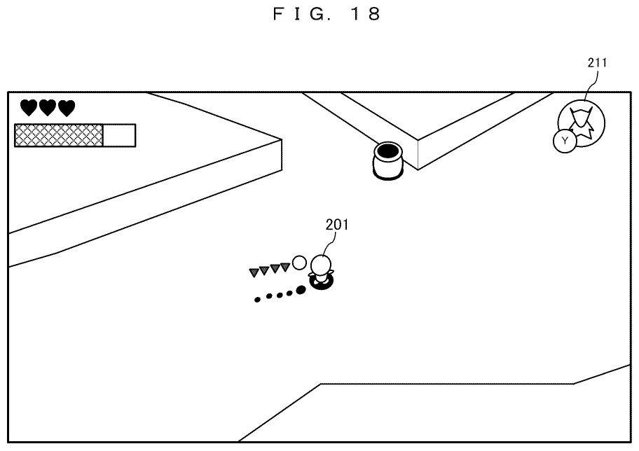

In the above description, the example in which the first action is performed to the pot 221 which does not autonomously move has been shown. Here, a screen example in which the first action is performed to the enemy character 222 will be described. In a case of the enemy character 222, first, it is necessary to attack the enemy character 222 so as to reduce its health to 0 and defeat the enemy character 222, in order to perform the first action. That is, by defeating the enemy character 222, an opportunity to perform the first action to the enemy character 222 is obtained. For example, a case where the enemy character 222 is defeated by being attacked using a predetermined method from the state shown in FIG. 16, is assumed. When the enemy character 222 is defeated, a game image shown in FIG. 17 is displayed. In FIG. 17, a spirit object 223 corresponding to the defeated enemy character 222 is displayed, and a glittering effect is displayed therearound. As the guide image 231, a ZR guide is indicated as in the case of FIG. 13. In this state, when the user presses the ZR-button 61, an imitation object corresponding to the kind of the enemy character 222 becomes available. Also in this case, the content of the guide image 231 is changed to a quick designation guide as in the case of FIG. 14. Then, when the user presses the A button 53, as shown in FIG. 18, an image in the designation box 211 is changed to the imitation object (imitation enemy) corresponding to the kind of the enemy character 222. For an enemy character 222 of a kind for which an imitation object has been made available once, a spirit object 223 thereof as described above will not be displayed even if the user defeats the enemy character 222 again after that. As described above, an enemy character 222 can be made available as an imitation object after the user defeats the enemy character 222. Thus, in game play, it becomes possible to use the imitation object in a state in which the user has understood the behavior thereof through a battle. In addition, it becomes possible to provide a motivation for battling a strong enemy in order to use a strong imitation object.

### [Second Action]

Next, the “second action” will be described. The second action is an action for causing an imitation object “set” in the designation box 211 to appear on the field. In the exemplary embodiment, by pressing the Y button 56, the PC 201 is caused to make a motion according to the second action. Along with this, one unit of the imitation object set in the designation box 211 is caused to appear at a position adjacent to and in front of the PC 201.

Here, in the exemplary embodiment, an “appearance cost” for causing an imitation object to appear is set. For example, an appearance cost for an imitation pot is “1”, and an appearance cost for an imitation enemy is “2”. In this way, appearance costs are set for respective kinds of imitation objects. In a case of causing an imitation object to appear, an appearance cost corresponding to the imitation object is to be used. In the exemplary embodiment, the index 203 also serves to indicate the appearance cost. As it were, the index 203 is an index for the appearance cost. Specifically, one index 203 corresponds to an appearance cost of 1. Hereinafter, the maximum value of the appearance cost that the PC 201 can have is referred to as an “upper limit cost”. The cost indicated by the index 203 following the PC 201 at present is referred to as a “remaining cost”. For example, the example in FIG. 8 is a state in which there are no imitation objects appearing. Then, since four indices 203 are displayed in total, this state indicates that the upper limit cost and the remaining cost that the PC 201 has are both “4”. In the exemplary embodiment, a plurality of imitation objects can be caused to appear on the field as long as the upper limit cost is not exceeded. In the example in FIG. 8, imitation objects that can be caused to appear at the same time are limited to a case where the total cost is not greater than 4. For example, in a case of an imitation pot for which the appearance cost is “1”, up to four imitation pots can be caused to appear at the same time. As another example, in a case of an imitation enemy for which the appearance cost is “2”, up to two imitation enemies can be caused to appear at the same time. In addition, as long as the total cost is within the upper limit cost, different kinds of imitation objects can be caused to appear. For example, two imitation pots for which the appearance cost is “1” and one imitation enemy for which the appearance cost is “2” can be caused to appear.

The upper limit cost can be increased as the game progresses. For example, the support character 202 has a growth feature so that, as the support character 202 gains a level, the number of the indices 203 can be increased, i.e., the upper limit cost can be increased.

### [Deletion of Imitation Object]

Next, a case where an imitation object that is appearing is deleted will be described. In the exemplary embodiment, first, by the user performing a predetermined “deletion operation”, one imitation object adjacent to and in front of the PC 201 can be deleted. The deletion operation is performed by, for example, pressing the ZR-button 61. In addition, irrespective of whether or not the deletion operation is performed, an imitation object is deleted also when the imitation object satisfies a predetermined deletion condition. An example of such a case is when an imitation enemy is defeated by being attacked by the enemy character 222. Another example is a case where the PC 201 lifts and throws the imitation pot and thus the imitation pot is broken. Then, when such deletion of an imitation object occurs, the appearance cost for the deleted imitation object is restored to the PC 201 (the remaining cost increases).

In this example, it is possible to delete all of imitation objects that are appearing, by performing an “all-deletion operation”. The “all-deletion operation” is performed by, for example, holding down the ZR-button 61. In the exemplary embodiment, an operation on the ZR-button 61 is selectively used as any of an operation of executing the first action, an operation of deleting one imitation object, and an operation of deleting all of imitation characters, in accordance with the situation.

### Action Examples and Screen Examples Relevant to Second Action

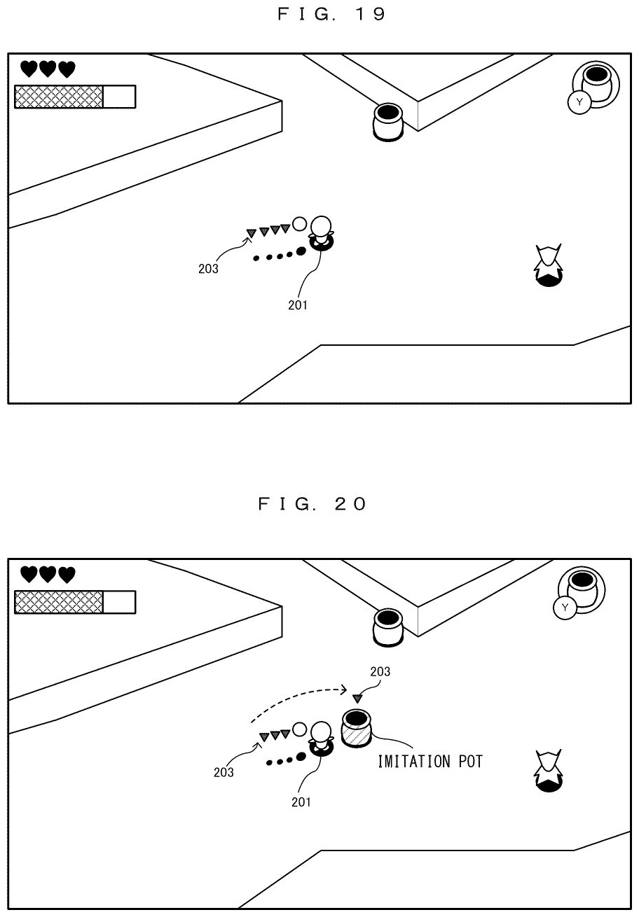

Hereinafter, screen examples when the second action is performed will be described. First, for example, in a situation in FIG. 19, when the user has performed the second action operation, an imitation pot appears in front of the PC 201, as shown in FIG. 20. At this time, a scene in which one of the indices 203 moves to a position upward of the imitation pot (hereinafter, movement representation) is displayed. By showing the user such movement of the index 203, it is visually indicated that the appearance cost is consumed by “1” for causing the imitation pot to appear. In addition, the moved index 203 moves while following the imitation object as described above. For example, in a case where the PC 201 moves the placed imitation pot by performing an action of lifting the imitation pot or the imitation pot that has appeared in the air drops, the index 203 moves to follow movement of the imitation pot. Therefore, the index 203 is always put above the imitation object. Thus, the user can recognize that an object is an imitation object, by confirming whether or not the index 203 is put. The index 203 moved to a position upward of the imitation object can also be considered to be an index indicating how much the appearance cost set for the imitation object is. Therefore, the user can also recognize an appearance cost needed for the imitation object, by confirming the number of the put indices 203.

In FIG. 20, as one index 203 has moved, there are three indices 203 remaining following the PC 201. That is, the user can also recognize that the remaining cost that the PC 201 has is “3”.

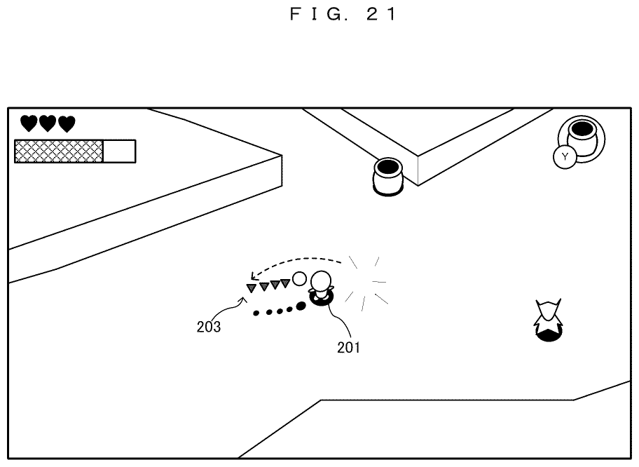

If the user performs a deletion operation in the situation in FIG. 20, the imitation pot is deleted and the index 203 put at the imitation pot comes back to a position following the support character 202, as shown in FIG. 21. Thus, it is indicated that the appearance cost is restored as a result of deletion. In FIG. 21, it is indicated that the remaining cost has become 4.

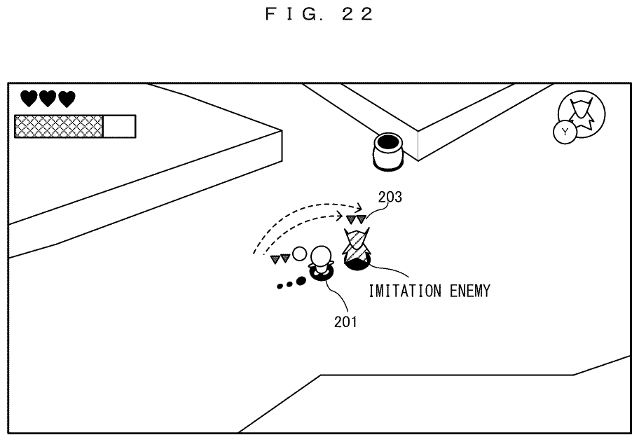

FIG. 22 shows an example in which an imitation enemy for which the appearance cost is “2” is caused to appear. In this case, two indices 203 are put at a position above the head of the imitation enemy. As a result, the number of the indices 203 following the PC 201 becomes 2, thus indicating that the remaining cost that the PC 201 has is “2”. Although not shown, if the user performs a deletion operation or the imitation enemy is defeated as described above, the two indices 203 come back.

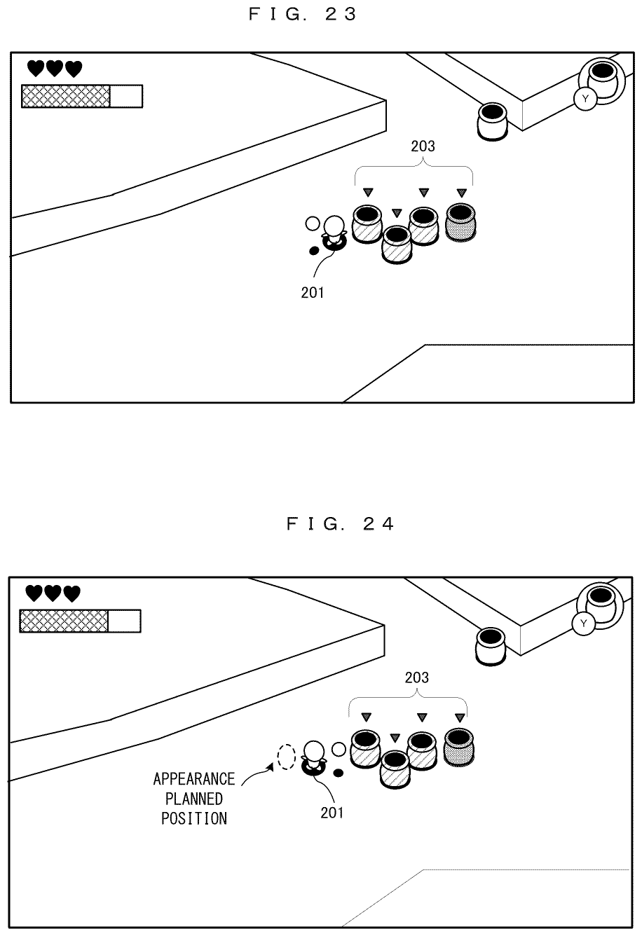

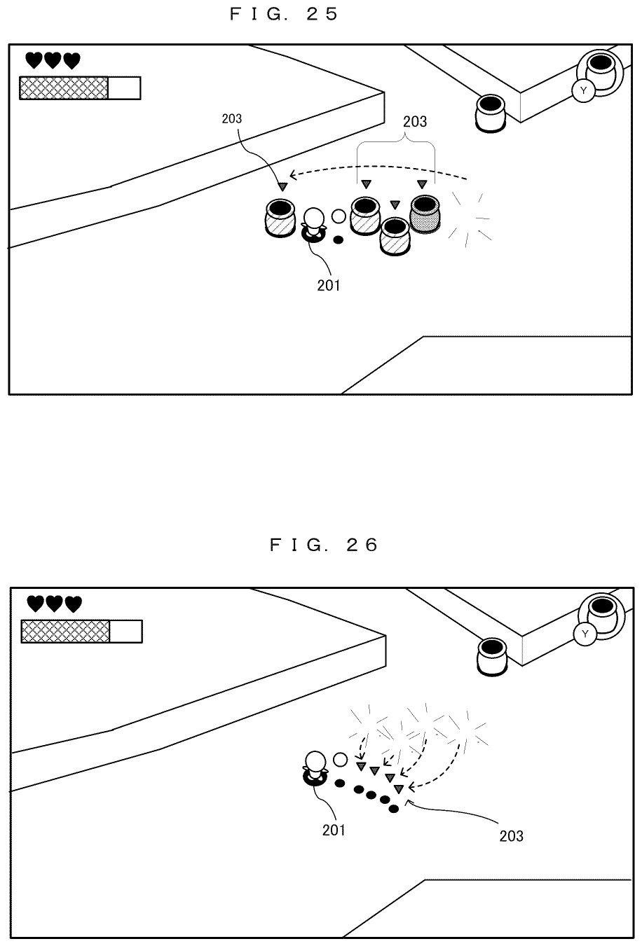

Next, a case where imitation objects are appearing up to the upper limit cost and the second action is further performed, will be described. In this case, in the exemplary embodiment, the existing imitation object is automatically deleted in the order from the oldest one, to secure the appearance cost, and a new imitation object is caused to appear using the secured appearance cost. In other words, control is performed so as to avoid such a situation that nothing happens when the second action is performed. In a case where the user performs a second action operation, the user wants to cause the imitation object to appear (in front of the PC 201). Therefore, rather than keeping the placed imitation objects, causing a new imitation object to appear is prioritized, whereby a smooth operation can be performed. FIG. 23 shows a screen example in which four imitation pots which reach the upper limit cost are caused to appear. In FIG. 23, one index 203 is put at each of the plurality of imitation pots. Thus, the remaining cost of the PC 201 is 0. Here, in FIG. 23, only one of the imitation pots is displayed in a display manner different from those of the other imitation pots. Thus, it is indicated that the imitation pot displayed in a different manner is the one caused to appear earliest among the imitation pots appearing at present. In this state, as shown in FIG. 24, it is assumed that, with the PC 201 facing leftward, the user performs an appearance instruction operation to cause an imitation pot to further appear. In the case of FIG. 24, a position at the left of the PC 201 is an appearance planned position for an imitation pot. In this case, in the exemplary embodiment, as shown in FIG. 25, the imitation pot caused to appear earliest is deleted and an imitation pot is caused to newly appear, using the appearance cost that has been used for the deleted imitation pot. Accordingly, a scene in which the index 203 moves to a position upward of the imitation pot that has newly appeared, is displayed. Along with this, the imitation pot caused to appear earliest is changed and the display manner thereof is changed. As described above, in the exemplary embodiment, in a case where imitation objects are appearing up to the upper limit cost and the second action is further performed, control is performed so that the existing imitation object is deleted in the order from the oldest one and an imitation object is caused to newly appear, instead of performing control so as to prohibit an imitation object from appearing any more. In addition, as described above, the display manner of the oldest imitation object is made different from the other imitation objects, thus making it easy for the user to recognize which imitation object will be deleted if an appearance instruction operation is performed.

In the state in FIG. 24, if an all-deletion operation is performed, all the indices 203 put at the respective imitation pots come to positions following the support character 202, as shown in FIG. 26. Thus, it is indicated that the remaining cost is restored to the upper limit cost.

Here, supplementary explanation will be given about the appearance position of an imitation object. In the exemplary embodiment, in principle, an imitation object is caused to appear at a position in front of the PC 201. However, in a case where the front position is such a place where an imitation object cannot be placed, the following control is performed in the exemplary embodiment. First, an imitation object is displayed at the front position once while ignoring collision with a terrain or the like. Next, after displayed, the imitation object is deleted immediately. For example, the imitation object is deleted after being displayed for about 1 second. At this time, change in the appearance cost is not caused. That is, such a representation that the imitation object is displayed during a short period and then is deleted immediately, is performed, thus telling the user that the position is a position where appearance is impossible.

Hereinafter, regarding the indices 203, the indices 203 controlled so as to follow the PC 201 may be collectively referred to as “remaining indices”, and the indices 203 placed upward of the imitation object and controlled so as to perform follow-up movement may be collectively referred to as “in-use indices”. In addition, a position at which the index 203 moves while following the PC 201 (support character 202) may be referred to as a “follow-up position”, and a position at which the index 203 moves while following the imitation object may be referred to as an “in-use position”.

### [Setting Operation to Designation Box 211]

Next, an operation for setting an imitation object in the designation box 211 will be described. For setting to the designation box 211, first, there is a method of performing an operation in accordance with the quick designation guide displayed when an imitation object is newly made available, as described above. In a case of this operation, only an imitation object that has newly become available can be designated. In the exemplary embodiment, it is possible to designate a predetermined imitation object among a plurality of available imitation objects and set the designated imitation object in the designation box 211, through the following operations. Specifically, there are an operation using a “quick list” and an operation using a “picture book”.

### [Quick List]

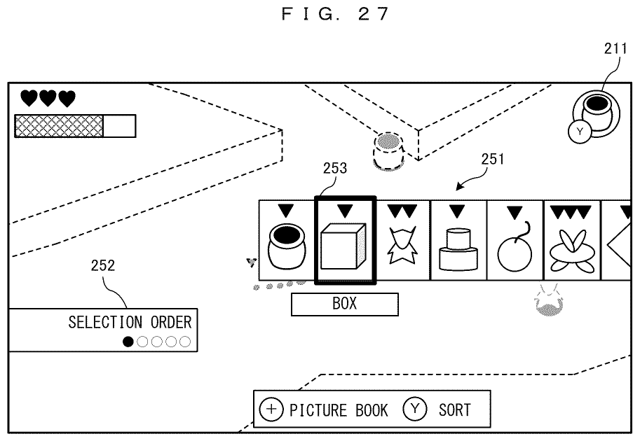

First, an operation using a “quick list” will be described. In the exemplary embodiment, when a predetermined operation is performed on a field screen, a quick list object (hereinafter, simply referred to as a quick list) 251 as shown in FIG. 27 is presented. The predetermined operation is an operation of pressing a predetermined button (hereinafter, quick list button) allocated for the quick list. In the exemplary embodiment, the quick list button is assumed to be the right direction button 33. While the right direction button 33 is being pressed (while an input thereof is ON), the quick list 251 as shown in FIG. 27 is presented. The quick list 251 is presented so as to be superimposed on the image of the field shown in FIG. 8 or the like. Then, when the user stops pressing the right direction button 33 (the input thereof is turned off), presentation of the quick list 251 is finished, thus returning to the field screen. While the quick list 251 is being presented, the behaviors of objects in the virtual space are stopped. That is, during presentation of the quick list 251, substantially, control is performed so as to pause progress of the game. In addition, while the quick list 251 is being presented, the display manner of the image of the virtual space is made different from that when the quick list 251 is not displayed. Specifically, the display manner may be changed to a blurred manner. In FIG. 27, difference in the display manner is expressed by dotted lines. Thus, the user can easily recognize that the behaviors of objects are paused, i.e., game progress is paused. Then, when presentation of the quick list 251 is finished, the paused state is canceled, so that the behaviors of objects are restarted. Hereinafter, a screen on which the quick list 251 (and a sort designation area object 252 described later) is being presented is referred to as a “quick list screen”.

The quick list 251 presents a one-dimensional array list in which icon images of imitation objects that have already been made available at present are arranged in a row. At the icon images of the imitation objects, images indicating appearance costs needed for appearance are also shown together. As the icon images, three-dimensional models of dynamic objects to appear in the game may be displayed, or two-dimensional images may be displayed. The user can select a desired imitation object from the quick list 251. Specifically, the user can move a cursor 253 in the horizontal direction in the quick list 251 by operating the right stick 52 while pressing the right direction button 33. Then, when the user stops pressing the right direction button 33, an imitation object selected by the cursor 253 at this time is set in the designation box 211.

On the quick list screen, the user can change the arrangement order of imitation characters displayed on the quick list 251. Specifically, definitions of arrangement orders in the quick list 251 are prepared as presets in advance. Then, every time the user presses a predetermined button (hereinafter, sort button) allocated for change of the arrangement order, each of the preset arrangement orders can be sequentially applied. In the exemplary embodiment, the button allocated as the sort button is assumed to be the Y button 56. On the quick list screen shown in FIG. 27, the sort designation area object (hereinafter, referred to as sort designation) 252 indicating the arrangement order at present is also displayed. The sort designation 252 indicates which arrangement order is applied at present among the preset arrangement orders. Examples of the preset arrangement orders include “selection order”, “acquisition order”, “Japanese syllabary order (alphabet order)”, and “cost order”. Every time the user presses the Y button 56, for example, the arrangement order to be applied can be switched in a predetermined sequence like “selection order”, “acquisition order”, “Japanese syllabary order (alphabet order)”, and then “cost order”. Along with this, the display content in the sort designation 252 is also changed so as to represent the arrangement order selected at present.

On the quick list screen, the user can switch the screen to a screen on which a “picture book” described below is presented, instead of the quick list 251, by pressing a picture book button. In the exemplary embodiment, a button allocated as the picture book button is assumed to be the +button 57. Also on a screen other than the quick list screen, the user can switch the screen to the “picture book” screen by pressing the +button 57.

### [Picture Book Screen]

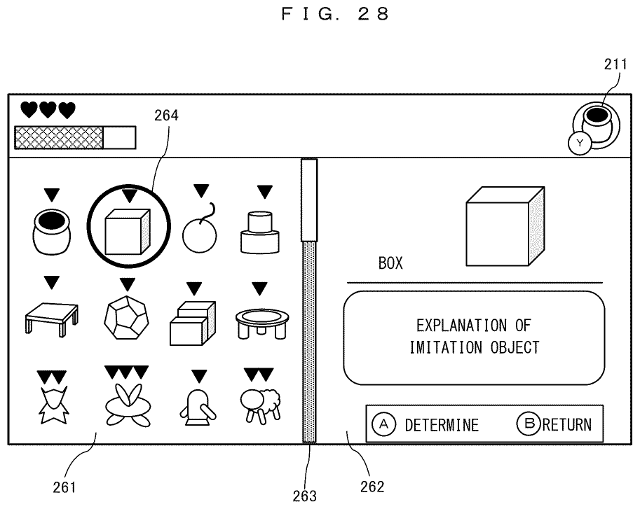

Next, an operation of using the “picture book” will be described. FIG. 28 shows a screen example (hereinafter, picture book screen) in which the “picture book” is presented. In FIG. 28, the picture book screen has display areas roughly divided between left and right, and a list area 261 and a detailed information area 262 are displayed at substantially a left half and substantially a right half, respectively. At a central part as a boundary between the two areas, a scroll bar 263 for scrolling the list area 261 in the vertical direction is displayed. In this example, these areas and the like are collectively referred to as a “picture book”.

In the list area 261, icon images of imitation objects that have already been made available at present are displayed in a format of a two-dimensional array list. In the list area 261, a cursor 264 is also displayed. The user can move the cursor 264 in the list area 261 by operating the right stick 52. In the detailed information area 262, detailed information about the imitation object selected by the cursor 264 at present is indicated. For example, an enlarged image of the imitation object and a text such as the name of the imitation object and explanation thereof are displayed in the detailed information area 262.

The user can select a predetermined imitation object from the list area 261 by moving the cursor 264. Then, the user can set the imitation object selected at present, in the designation box 211, by pressing the A button 53. In addition, by pressing the B button 54, the user can end the picture book screen, to return to the field screen. Also in the case of the picture book screen, the behaviors of objects in the virtual space are paused as in the case of the quick list. Then, when the picture book screen is ended by the B button 54, the paused state is canceled.

Here, on the quick list screen, when pressing of the right direction button 33 is ended, the designation box 211 is set and the screen returns to the field screen, but on the picture book screen, the screen does not return to the field screen unless the B button 54 is pressed. Therefore, on the picture book screen, a setting operation to the designation box 211 which has been performed once can be performed again, without experiencing any screen shift. As it were, on the quick list screen, the user can quickly change the content of the designation box 211 through a simple operation of merely turning on and off the right direction button 33 and moving the right stick 52 (only in the left-right direction). In addition, for example, in a case where the “selection order” which is one of the arrangement orders is applied, the imitation object caused to appear most recently is displayed at the top of the quick list 251. Therefore, in a case where the user desires to cause only a few kinds of imitation objects to appear in combination, e.g., a case where the user desires to cause two kinds of imitation objects to appear alternately, the user can switch designation just through a slight operation of the cursor 253 and thus can cause the imitation object to appear quickly. In contrast to the quick list screen on which such simple and quick operability is provided, on the picture book screen, the user can deeply think about selecting an imitation object to be set in the designation box 211 while considering the characteristics of the imitation objects and the like.

Regarding a selection operation on the picture book screen, in another exemplary embodiment, the following operation may be adopted. In the list area 261, the user moves the cursor 264 by the right stick 52, and when the A button 53 is pressed, the imitation object to be “selected” may be just changed without being set in the designation box 211. Then, when the B button 54 is pressed, the imitation object “selected” at this time may be set in the designation box 211 and the picture book screen may be ended.

In this example, it is assumed that change of the arrangement order as in the quick list cannot be performed on the picture book screen. However, in another exemplary embodiment, the arrangement order may be allowed to be changed as in the quick list.

In the exemplary embodiment, the example in which only imitation objects that have been made available at present are displayed in the list area 261, is shown. Therefore, as the number of available imitation objects increases, the number of contents displayed in the list area 261 also increases. In this regard, in another exemplary embodiment, all kinds of imitation objects including the ones that have not been made available yet may be displayed in the list area 261 from the beginning, and the imitation objects that have not been made available yet may be controlled so that they cannot be set in the designation box 211, while, for example, the display manner of these unavailable imitation objects may be changed.

As described above, in the exemplary embodiment, a plurality of methods are provided as a method for setting an imitation object in the designation box 211, and these methods can be selectively used in accordance with the situation, whereby convenience for the user is improved.

### [Transformation Gauge]

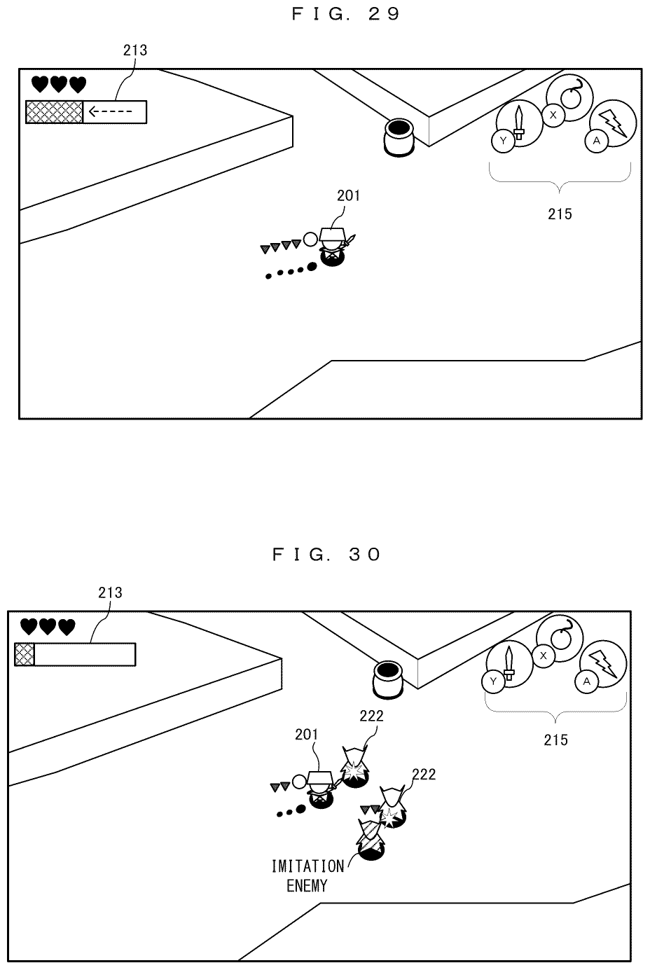

Next, the transformation gauge 213 will be described. In this game, in a state in which the transformation gauge 213 is filled, the user can “transform” the PC 201 to a different character by performing a “transformation operation”, as shown in FIG. 29. This state of the PC 201 is referred to as a “transformed state”. The transformation operation is performed by, for example, pressing the up direction button 35. During the transformed state, the transformation gauge 213 gradually decreases. Then, when the transformation gauge 213 has become empty (0), the transformed state is canceled. That is, a time limit is set for the transformed state. In the transformed state, the user can cancel the transformed state at an arbitrary timing by performing a transformation operation again. In the transformation gauge 213, a predetermined amount can be accumulated by defeating the enemy character 222 or acquiring a predetermined item, for example.

In the transformed state, the performance of the PC 201 is changed and the possible operation content thereof is also changed. Specifically, the PC 201 in the transformed state cannot perform the first action and the second action. Instead, the PC 201 can perform an attack action. Conversely, the PC 201 not in the transformed state cannot directly perform an attack action, and if the user wants to attack the enemy character 222, it is necessary to use an imitation object (e.g., an imitation enemy) to perform an attack, for example.

In this game, the user can cause the PC 201 in the transformed state to perform an attack action using three buttons, i.e., the Y button 56, the X button 55, and the A button 53. In this example, the three buttons are allocated with different attack methods, respectively. On the screen, as shown in FIG. 29, instead of the designation box 211, three attack operation boxes 215 are displayed near the upper right corner of the screen. In each attack operation box 215, an image indicating an attack method corresponding to each button is displayed.

Here, the Y button 56 is used for performing the second action in a case where the PC 201 is not in a transformed state. That is, when the PC 201 is in a transformed state, an operation of the Y button 56 serves as an operation of performing an attack action instead of executing the second action.

The imitation objects that are appearing also exist while the PC 201 is in a transformed state, and the imitation objects are controlled on the basis of behavior data set for the respective imitation objects. Therefore, for example, in a state in which imitation enemies are appearing, if the PC 201 is transformed, the PC 201 and the imitation enemy can perform a cooperative battle, as shown in FIG. 30. In this way, by causing an imitation object to appear and/or switching between two modes while proceeding with the game, various play styles can be provided.

### Details of Game Processing in the Exemplary Embodiment

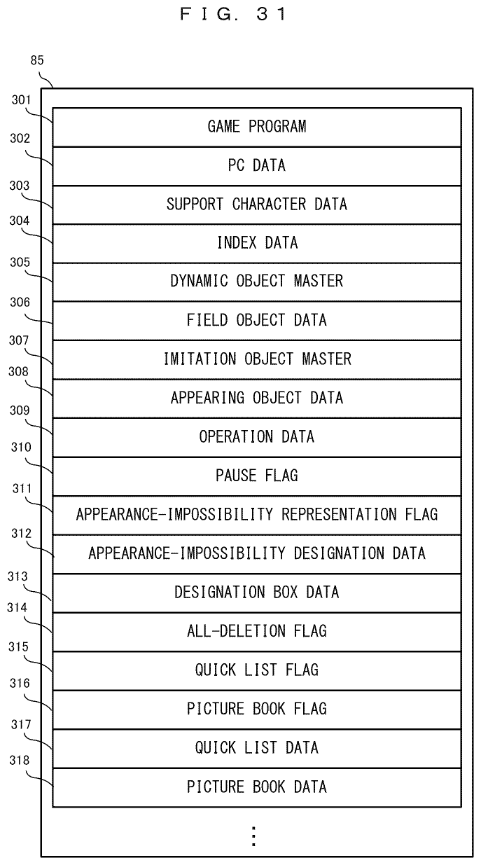

Next, with reference to FIG. 31 to FIG. 63, the game processing in the exemplary embodiment will be described in more detail.

### [Used Data]

First, various data used in this game processing will be described. FIG. 31 is a memory map showing an example of various data stored in the DRAM 85 of the main body apparatus 2. The DRAM 85 of the main body apparatus 2 stores a game program 301, PC data 302, support character data 303, index data 304, a dynamic object master 305, field object data 306, an imitation object master 307, appearing object data 308, operation data 309, a pause flag 310, an appearance-impossibility representation flag 311, appearance-impossibility designation data 312, designation box data 313, an all-deletion flag 314, a quick list flag 315, a picture book flag 316, quick list data 317, picture book data 318, and the like.

The game program 301 is a program for executing the game processing in the exemplary embodiment.

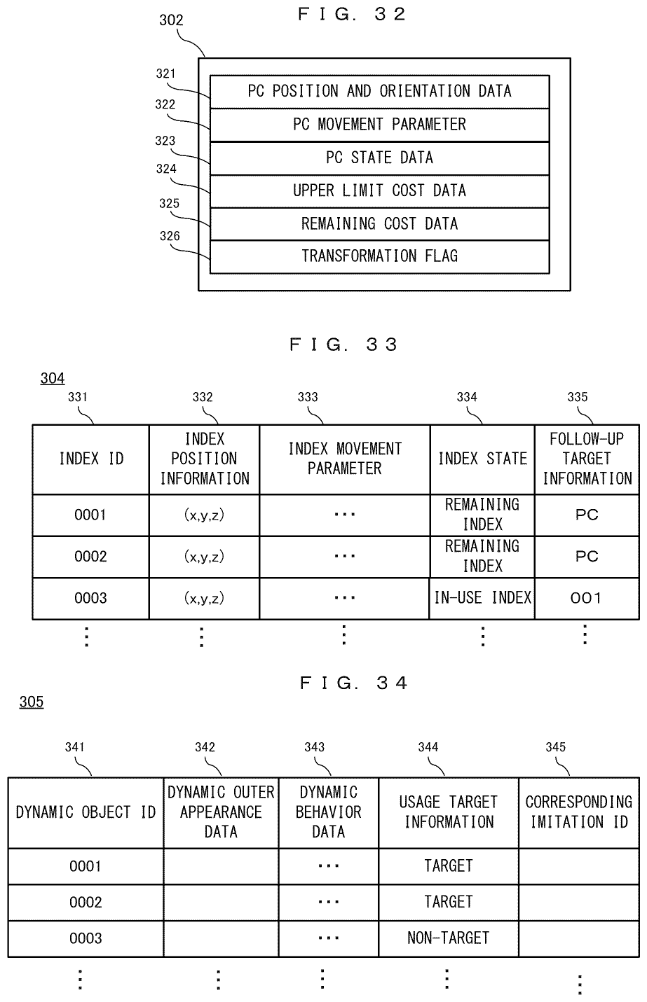

The PC data 302 is data about the PC 201. FIG. 32 shows an example of the data structure of the PC data 302. The PC data 302 includes at least PC position and orientation data 321, a PC movement parameter 322, PC state data 323, upper limit cost data 324, remaining cost data 325, and a transformation flag 326. In addition, although not shown, the PC data 302 includes various data needed in the game processing, such as image data indicating the outer appearance of the PC 201, the health value of the PC 201, data indicating the outer appearance and performance of the PC 201 in a transformed state, and data (animation data) of various motions to be made by the PC 201.

The PC position and orientation data 321 is data indicating the present position and the present orientation of the PC 201 in the virtual game space.

The PC movement parameter 322 is data used for movement control of the PC 201. For example, the PC movement parameter 322 includes parameters indicating the movement direction, the movement speed, and the like of the PC 201.

The PC state data 323 is data indicating a PC state which is the present state of the PC 201. In the PC state data 323, for example, data indicating various PC states such as a moving state, a jumping state, a standby state, a first action state, and a second action state are set as appropriate. Among various motions to be performed by the PC 201, a motion corresponding to the PC state can be reproduced. For example, in a case where the PC state is a “first action state”, a motion corresponding to the first action is reproduced.

The upper limit cost data 324 is data indicating an upper limit value of cost (upper limit cost) that the PC 201 has.

The remaining cost data 325 is data indicating the remaining cost (number of remaining indices) as described above.

The transformation flag 326 is a flag indicating whether or not the PC 201 is in a transformed state. An initial value thereof is OFF, and if the transformation flag 326 is ON, the transformation flag 326 indicates that the PC 201 is in a transformed state.

Returning to FIG. 31, the support character data 303 is data about the support character 202. The support character data 303 includes, for example, data indicating the present position and orientation of the support character 202, a movement parameter, information indicating the level of the support character 202, and the like.

Next, the index data 304 is data for controlling the index 203. FIG. 33 shows an example of the data structure of the index data 304. The index data 304 is data defined in a table format and including an index ID 331, index position information 332, an index movement parameter 333, an index state 334, and follow-up target information 335. Since the number of the indices 203 can change, the number of records in the index data 304 can increase with the number of the indices 203. The index ID 331 is an ID for identifying each index 203. The index position information 332 is information indicating the present position of each index 203. The index movement parameter 333 is a movement control parameter indicating the movement direction, the movement speed, and the like of each index 203. The index state 334 is information indicating whether the index 203 is a remaining index or an in-use index. An initial value of the index state 334 is set as information indicating a remaining index. The follow-up target information 335 is information for specifying a target that the index 203 moves to follow. In a case where the index 203 is a remaining index, the follow-up target information 335 is set to be information indicating the PC 201. For example, this information is a special ID or the like indicating the PC 201. In a case where the index 203 is an in-use index, the follow-up target information 335 is set to be information indicating an imitation object that is a target to be followed. Specifically, this information is an AOID 371 described later.

Returning to FIG. 31, next, the dynamic object master 305 is master data in which all dynamic objects to be used in this game are defined on a kind basis. FIG. 34 shows an example of the data structure of the dynamic object master 305. The dynamic object master 305 is data in a table format including at least the following items: a dynamic object ID 341, dynamic outer appearance data 342, dynamic behavior data 343, usage target information 344, and corresponding imitation ID 345. The dynamic object ID 341 is an ID for identifying each dynamic object. The dynamic outer appearance data 342 is data such as model data indicating the outer appearance of the dynamic object and image data of a texture or the like. The dynamic behavior data 343 is data defining the behavior of the dynamic object. Each dynamic object present on the field (hereinafter, referred to as a field object, which is abbreviated as FO) is subjected to action control on the basis of the definition content in the dynamic behavior data 343. The usage target information 344 is information indicating whether or not the dynamic object of each kind is a target of the first action. In this game, for example, imitation objects are not prepared for some kinds of dynamic objects, e.g., NPCs. That is, dynamic objects other than targets of the first action are also present. The usage target information 344 indicates whether or not each dynamic object is such a kind of dynamic object other than a target of the first action. Therefore, in the usage target information 344, information indicating whether or not the dynamic object of each kind is a usage target, is defined. The corresponding imitation ID 345 is information for specifying an imitation object corresponding to the dynamic object. Specifically, any of the imitation object IDs 361 in the imitation object master 307 described later is specified.

Returning to FIG. 31, next, the field object data (hereinafter, referred to as FO data) 306 is data for managing FOs which are dynamic objects placed in the game field (virtual space) at present. For example, in a case of the pot 221, data of the “pot” in the dynamic object master 305 is referred to, whereby a plurality of the pots 221 can be generated and placed on the field. The FO data 306 is data for managing the plurality of pots 221 that are placed.

FIG. 35 shows an example of the data structure of the FO data 306. As shown in FIG. 35, the FO data 306 is data in a table format including at least the following items: an FOID 351, a reference source ID 352, FO position information 353, and an FO state 354. The FOID 351 is an ID for uniquely identifying each FO. The reference source ID 352 is information indicating which kind of dynamic object the FO is. Specifically, any of the dynamic object IDs 341 in the dynamic object master 305 is specified. Each FO is controlled on the basis of the dynamic behavior data 343 of a dynamic object of a kind specified by the reference source ID 352. The FO position information 353 is information indicating the present position of each FO. The FO state 354 is information indicating the present state of each FO. For example, the FO state 354 indicates a state such as an action that the FO is performing at present, e.g., an attacking state or a moving state. Also, various motions to be reproduced by each FO can be determined on the basis of the FO state 354.

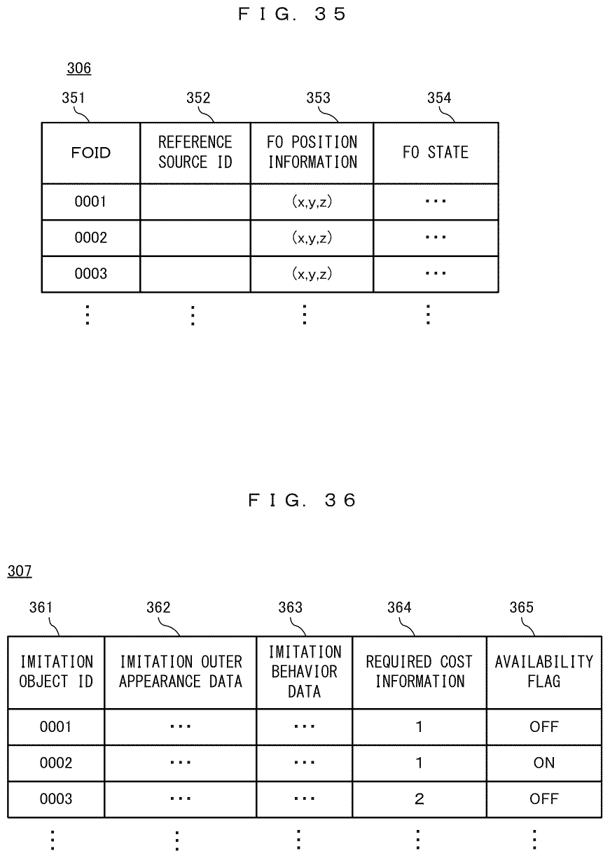

Returning to FIG. 31, next, the imitation object master 307 is master data defining the imitation objects. FIG. 36 shows an example of the data structure of the imitation object master 307. The imitation object master 307 is data in a table format including at least the following items: an imitation object ID 361, imitation outer appearance data 362, imitation behavior data 363, required cost information 364, and an availability flag 365. The imitation object ID 361 is an ID for identifying an imitation object of each kind. The imitation outer appearance data 362 is data such as model data indicating the outer appearance of the imitation object and image data of a texture or the like. For example, as the model data, the same data as the dynamic object may be shared. In addition, the imitation outer appearance data 362 may include data such as a drawing setting and a texture image needed for making the display manner different. The imitation behavior data 363 is data defining the behavior of an imitation object of each kind. In the exemplary embodiment, as described above, regarding behaviors defined by the imitation behavior data 363, at least partially, the same data as for behaviors defined by the dynamic behavior data 343 are defined. The required cost information 364 is information defining an appearance cost needed for causing one unit of an imitation object of each kind to appear. The availability flag 365 is information indicating whether or not an imitation object of each kind has already been made available by the first action. In addition, although not shown, the imitation object master 307 includes various information needed in the game processing, e.g., an explanation text to be displayed in the detailed information area 262 on the picture book screen.

Returning to FIG. 31, next, the appearing object data 308 is data for managing each imitation object that is appearing on the field at present by the second action. Hereinafter, imitation objects that are appearing in the field at present are collectively referred to as appearing objects (hereinafter, AOs). FIG. 37 shows an example of the data structure of the appearing object data 308. The appearing object data 308 is data in a table format including at least the following items: an AOID 371, a reference source imitation ID 372, AO position information 373, and an AO state 374. The AOID 371 is an ID for uniquely identifying each AO. The reference source imitation ID 372 is information indicating which kind of imitation object the AO is. Specifically, any of the imitation object IDs 361 in the imitation object master 307 is specified. Each AO can be controlled on the basis of the imitation behavior data 363 of an imitation object of a kind specified by the reference source imitation ID 372. The outer appearance of each AO is also based on the imitation outer appearance data 362 of an imitation object of a kind specified by the reference source imitation ID 372. The AO position information 373 is information indicating the present position of each AO. The AO state 374 is information indicating the present state of each AO. For example, the AO state 374 indicates a state such as an action that the AO is performing at present, e.g., an attacking state or a moving state. In addition, as the AO state 374, an “appearance preparing state” indicating that a representation for the AO to appear (hereinafter, appearing representation) is being reproduced or a “deleting state” indicating that a representation for deletion (hereinafter, deletion representation) is being reproduced, can be set as appropriate. Also, various motions to be reproduced by each AO can be determined on the basis of the AO state 374.

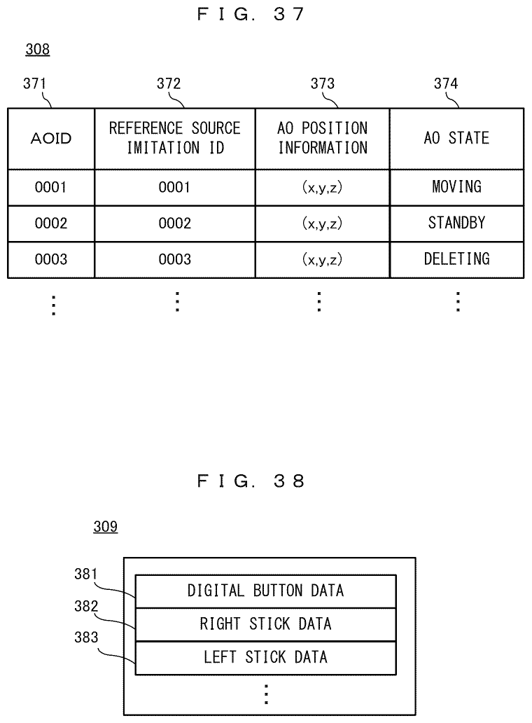

Returning to FIG. 31, next, the operation data 309 is data obtained from a controller operated by the user. That is, the operation data 309 is data indicating the content of an operation performed by the user. FIG. 38 shows an example of the data structure of the operation data 309. The operation data 309 includes at least digital button data 381, right stick data 382, and left stick data 383. The digital button data 381 is data indicating the press state of each button that the controller has. The right stick data 382 is data indicating the content of an operation on the right stick 52. The left stick data 383 is data indicating the content of an operation on the left stick 32.

Returning to FIG. 31, next, the pause flag 310 is a flag indicating whether or not the present play state is a state in which the quick list screen or the picture book screen is displayed. An initial value of the pause flag 310 is OFF. If the pause flag 310 is ON, the pause flag 310 indicates that the quick list screen or the picture book screen is displayed and progress of the game is substantially in a paused state.

The appearance-impossibility representation flag 311 is a flag indicating whether or not a representation indicating that an imitation object cannot appear as described above is being reproduced. The appearance-impossibility designation data 312 is data for designating an imitation object to be displayed for an instant in the appearance-impossibility representation.

The designation box data 313 is data (imitation object ID 361) for specifying an imitation object designated in the designation box 211 at present. In other words, an imitation object set in the designation box data 313 is displayed in the designation box 211.

The all-deletion flag 314 is a flag for determining whether or not the all-deletion operation has been performed. If the all-deletion flag 314 is ON, the all-deletion flag 314 indicates that the all-deletion operation has been performed.

The quick list flag 315 is a flag for determining whether or not the present state is a state in which the quick list 251 as shown in FIG. 27 should be presented. The picture book flag 316 is a flag for determining whether or not the present state is a state in which the picture book as shown in FIG. 28 should be presented.

The quick list data 317 is data as a base of the quick list 251 as shown in FIG. 27. That is, the quick list data 317 is data in which a list of available imitation objects are stored. In addition, the quick list data 317 includes information indicating a content selected at present in the quick list. The content of the quick list data 317 is updated at a timing when an available imitation object is added.

The picture book data 318 is data as a base of the picture book screen as shown in FIG. 28. As with the quick list data 317, the picture book data 318 is data in which a list of available imitation objects is stored. In addition, the picture book data 318 includes information indicating a content selected at present on the picture book screen. The content of the picture book data 318 is updated at a timing when an available imitation object is added.

Other than the above data, various data needed in the game processing are generated as appropriate and are stored in the DRAM 85.

### [Details of Processing Executed by Processor 81]

Next, the details of the game processing in the exemplary embodiment will be described. Here, control relevant to the imitation object will be mainly described, while the detailed description of other relevant game processing is omitted. Flowcharts shown below are merely examples of processing procedures. Therefore, the processing order of steps may be changed as long as the same result is obtained. In addition, the values of variables and thresholds used in determination steps are also merely examples and other values may be used as necessary.

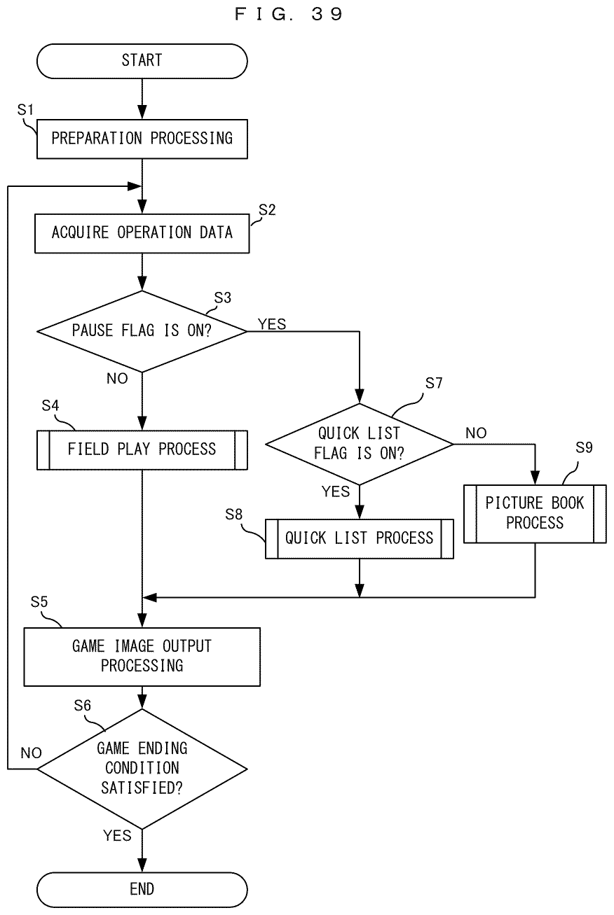

FIG. 39 is a flowchart showing the details of the game processing according to the exemplary embodiment. Execution of the process in the flowchart is started in accordance with an instruction to start game play from a user. In FIG. 39, first, in step S1, the processor 81 executes preparation processing. In this processing, a virtual space is constructed on the basis of predetermined stage data (not shown) defining terrains and the like in a virtual space, and the PC 201, various dynamic objects (FOs), and the like are generated and placed at predetermined positions. In addition, various data to be used in the following processing are initialized. Then, a game image obtained by capturing a virtual space by a virtual camera from a viewpoint corresponding to the above-described top view is displayed. Then, while waiting for an operation from the user, game play is started. The processing described below is processing common between a case where the game image is a top view image and a case where the game image is a side view image as described above.

Next, in step S2, the processor 81 acquires the operation data 309.

Next, in step S3, the processor 81 determines whether or not the pause flag 310 is ON. As a result of the determination, if the pause flag 310 is not ON (NO in step S3), in step S4, the processor 81 executes a field play process.

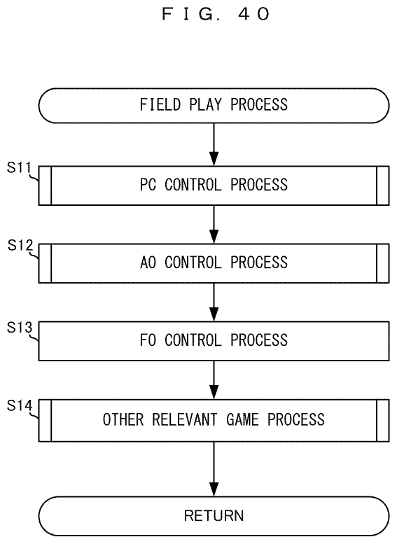

FIG. 40 is a flowchart showing the details of the field play process. In FIG. 40, first, in step S11, the processor 81 executes a PC control process for controlling the PC 201.

### [Control Processing for PC 201]

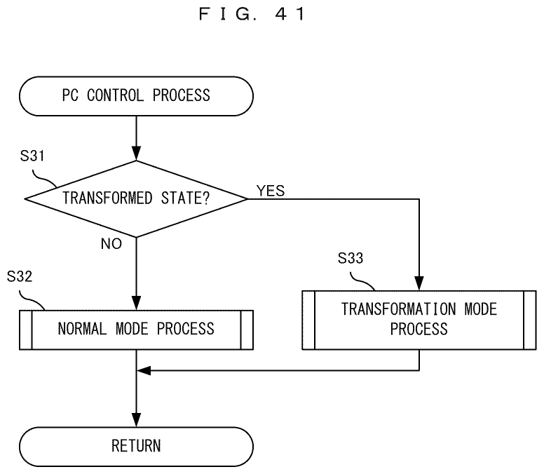

FIG. 41 shows the details of the PC control process. In FIG. 41, first, in step S31, the processor 81 determines whether or not the PC 201 is in a transformed state, with reference to the transformation flag 326. As a result of the determination, if the PC 201 is in a transformed state (YES in step S31), in step S33 described later, the processor 81 executes a transformation mode process. On the other hand, if the PC 201 is not in a transformed state (NO in step S31), in step S32, the processor 81 executes a normal mode process.

[Processing when PC 201 is not in Transformed State]

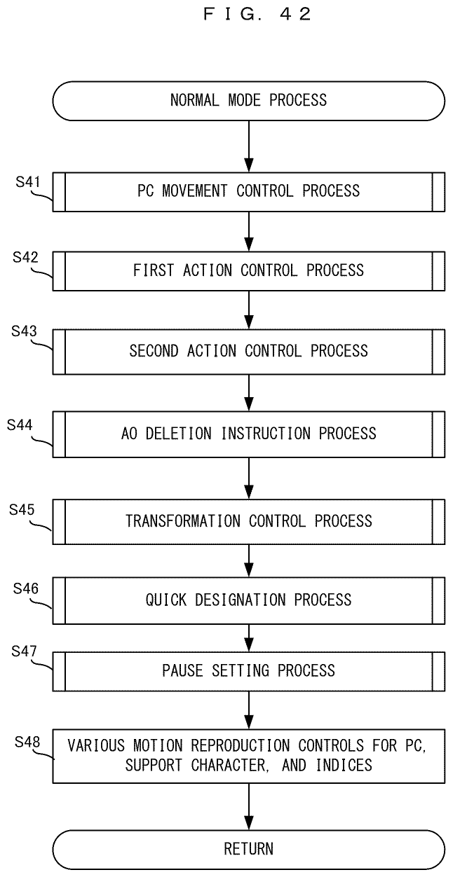

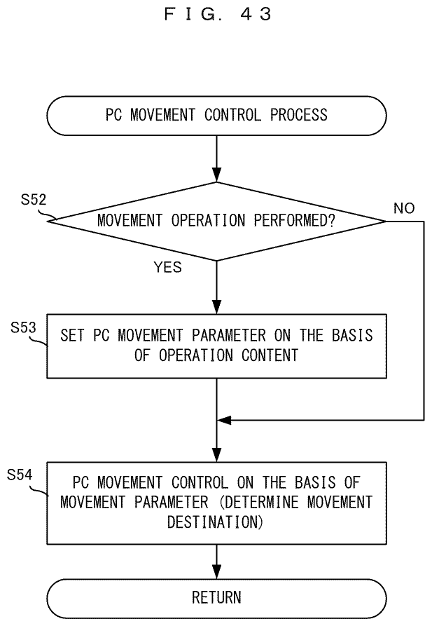

FIG. 42 is a flowchart showing the details of the normal mode process. In FIG. 42, first, in step S41, the processor 81 executes a movement control process. FIG. 43 shows the details of the movement control process. In FIG. 43, first, in step S52, the processor 81 determines whether or not a movement operation has been performed, on the basis of the operation data 309. As a result of the determination, if a movement operation has been performed (YES in step S52), in step S53, the processor 81 sets the PC movement parameter 322 on the basis of the operation content. If a movement operation has not been performed (NO in step S52), the processing in step S53 is skipped. Next, in step S54, the processor 81 performs movement control for the PC 201 on the basis of the PC movement parameter 322. Along with this, the processor 81 updates movement parameters of the support character data 303 and the index data 304 so that the support character 202 and the remaining indices follow the PC 201. Then, on the basis of the support character data 303 and the index data 304, the processor 81 performs movement control for the support character 202 and the remaining indices. Thus, the PC movement control process has ended.

### [Control Processing Relevant to First Action]

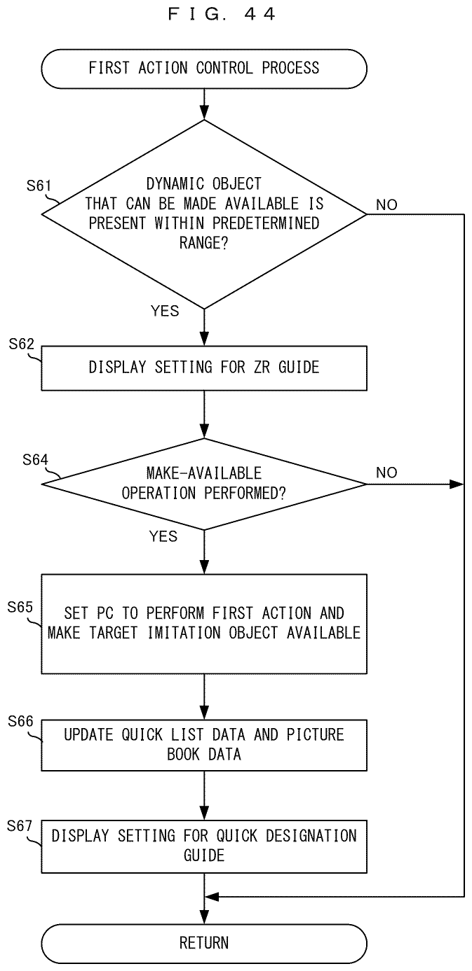

Returning to FIG. 42, next, in step S42, the processor 81 executes a first action control process. FIG. 44 is a flowchart showing the details of this process. In FIG. 44, first, in step S61, the processor 81 determines whether or not a FO that can be made available by the first action, in this example, a FO imparted with the glittering effect, and the PC 201 are in a predetermined positional relationship. For example, the processor 81 determines whether or not such a FO is present within a predetermined distance in a frontward direction of the PC 201. As a result of the determination, if such a FO is not present (NO in step S61), the processor 81 ends the first action control process. On the other hand, if such a FO is present (YES in step S61), in step S62, the processor 81 performs setting for displaying the ZR guide as shown in FIG. 13 while the above positional relationship is kept.

Next, in step S64, the processor 81 determines whether or not the make-available operation (pressing the ZR-button 61) has been performed, on the basis of the operation data 309. As a result of the determination, if the make-available operation has not been performed (NO in step S64), the processor 81 ends the first action control process. If the make-available operation has been performed (YES in step S64), in step S65, the processor 81 performs setting for the PC 201 to reproduce a motion corresponding to the first action. Further, the processor 81 makes available an imitation object of a kind corresponding to the kind of a dynamic object for which the make-available operation has been performed. That is, the processor 81 sets ON for the availability flag 365 for the imitation object of the corresponding kind in the imitation object master 307.

Next, in step S66, the processor 81 updates the quick list data 317 and the picture book data 318 so that the imitation object that has been newly made available is reflected therein. Specifically, the processor 81 adds the imitation object of the kind that has been made available, to the quick list data 317 and the picture book data 318.

Next, in step S67, the processor 81 performs display setting for displaying the quick designation guide as shown in FIG. 14 instead of the ZR guide during a predetermined period. Then, the processor 81 ends the first action control process.

### [Second Action Control Process]

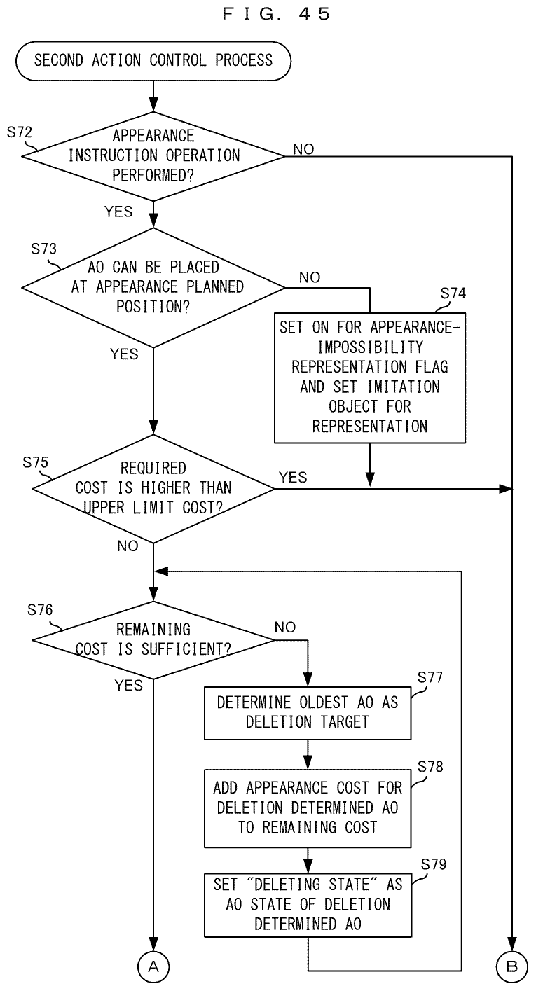

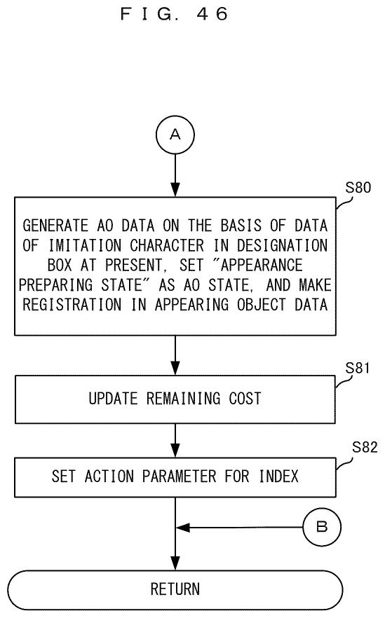

Returning to FIG. 42, next, in step S43, the processor 81 executes a second action control process. This process is executed when the appearance instruction operation has been performed. FIG. 45 and FIG. 46 are flowcharts showing the details of this process. In FIG. 45, first, in step S72, the processor 81 determines whether or not the appearance instruction operation (pressing the Y button 56) has been performed, on the basis of the operation data 309. As a result of the determination, if the appearance instruction operation has not been performed (NO in step S72), the processor 81 ends the second action control process. On the other hand, if the appearance instruction operation has been performed (YES in step S72), in step S73, the processor 81 determines whether or not the appearance planned position is a position where the AO can be placed. As a result of the determination, if the appearance planned position is a position where the AO cannot be placed (NO in step S73), in step S74, the processor 81 sets ON for the appearance-impossibility representation flag 311. Further, the processor 81 sets, in the appearance-impossibility designation data 312, an ID of the imitation object designated in the designation box data 313 at present (hereinafter, designated object). Then, the processor 81 ends the second action control process.

On the other hand, if the appearance planned position is a position where the AO can be placed (YES in step S73), in step S75, the processor 81 determines whether or not the required cost for the designated object is greater than the upper limit cost. That is, the processor 81 determines whether or not the user is trying to cause such an imitation object that cannot be caused to appear at present unless the upper limit cost is further increased, to appear. As a result of the determination, if the required cost is greater than the upper limit cost that the PC 201 has at this time (YES in step S75), the processor 81 ends the second action control process. At this time, the processor 81 may perform control so as to display the fact that the cost is deficient.

On the other hand, if the required cost is equal to or smaller than the upper limit cost of the PC 201 at this time (NO in step S75), in step S76, the processor 81 determines whether or not the remaining cost is equal to or greater than the required cost for the designated object. That is, whether or not the remaining cost at present is sufficient is determined. As a result of the determination, if the remaining cost is not sufficient (NO in step S76), in step S77, the processor 81 determines the AO caused to appear earliest, as a deletion target. Next, in step S78, the processor 81 adds the appearance cost for the AO determined as a deletion target (hereinafter, deletion target AO), to the remaining cost. In subsequent step S79, the processor 81 sets a “deleting state” as the AO state 374 for the deletion target AO. In addition, for the AO that is next oldest after the deletion target AO, the processor 81 performs setting to make the display manner different from those of the other AOs so that the user can find that the next oldest AO becomes the oldest. Then, the process returns to step S76, so as to be repeated.

On the other hand, as a result of the determination in step S76, if the remaining cost is sufficient (YES in step S76), in step S80 in FIG. 46, the processor 81 generates data of the AO on the basis of data of the designated object, and makes registration in the appearing object data 308. At this time, an “appearance preparing state” is set as the AO state 374. In addition, the coordinates of the appearance planned position are set as the AO present position. In a case where a plurality of AOs appear, the processor 81 also performs, for the AO caused to appear earliest, such setting as to make the display manner thereof different from the other AOs. In addition, the processor 81 performs setting for causing the PC 201 to reproduce a motion corresponding to the second action.

Next, in step S81, the processor 81 subtracts the appearance cost for the AO caused to appear at this time, from the remaining cost. Then, the processor 81 ends the second action control process.

Next, in step S82, the processor 81 sets an action parameter for performing a movement representation as shown in FIG. 20 or FIG. 22. Specifically, the processor 81 determines the number of the indices 203 corresponding to the appearance cost for the AO to be caused to appear, from the remaining indices. Next, the processor 81 sets information indicating “in-use index” for the index states 334 of the determined indices 203, and sets the AOID 371 of the AO caused to appear at this time, in the follow-up target information 335. Then, the processor 81 sets the index position information 332 and the index movement parameter 333 as appropriate so that the indices 203 move to the in-use positions above the AO caused to appear.

### [Processing for AO Deletion Instruction]

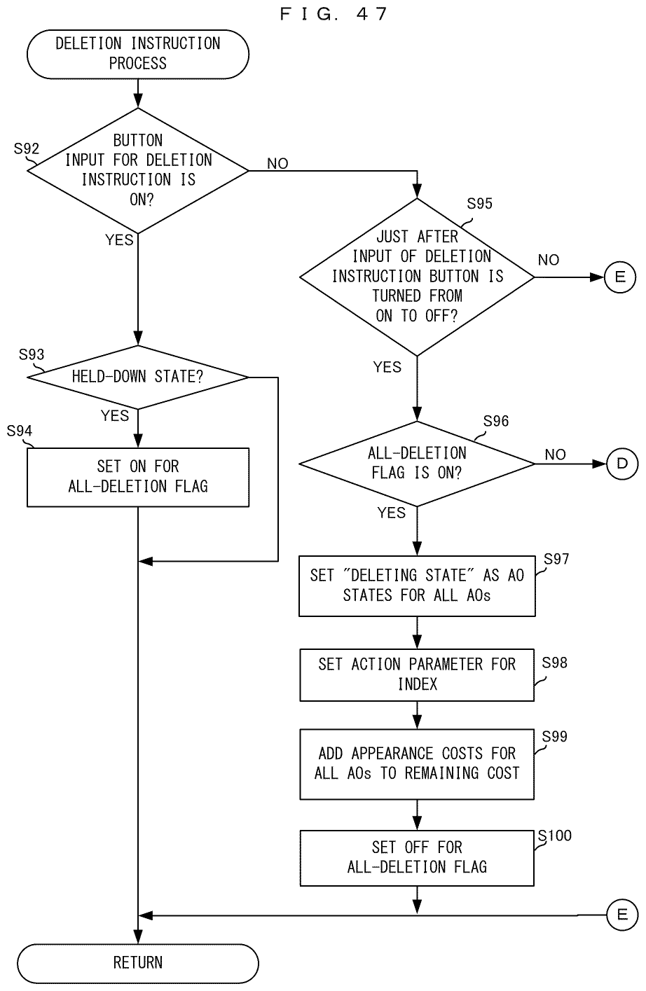

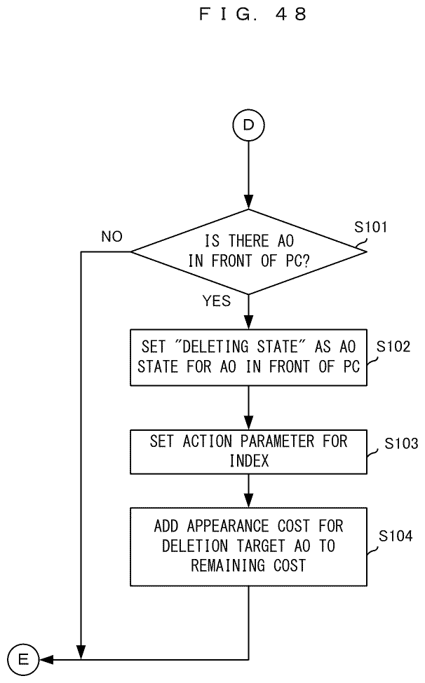

Returning to FIG. 42, next, in step S44, the processor 81 executes an AO deletion instruction process. This process is executed when the deletion operation or the all-deletion operation has been performed. FIG. 47 and FIG. 48 are flowcharts showing the details of the AO deletion instruction process. In FIG. 47, first, in step S92, the processor 81 determines whether or not a button input corresponding to a deletion instruction is ON, on the basis of the operation data 309. In this example, the ZR-button 61 is used for a deletion instruction. Therefore, whether or not the ZR-button 61 is ON is determined. As a result of the determination, if the ZR-button 61 is ON (YES in step S92), in step S93, the processor 81 determines whether or not the ZR-button 61 is in a held-down state of being continuously pressed for a predetermined period or longer, i.e., whether or not the all-deletion operation has been performed. As a result of the determination, if the all-deletion operation has been performed (YES in step S93), in step S94, the processor 81 sets ON for the all-deletion flag 314. Then, the processor 81 ends the deletion instruction. On the other hand, if the all-deletion operation has not been performed yet (NO in step S93), the processing in step S94 is skipped.

On the other hand, as a result of the determination in step S92, if the ZR-button 61 is not ON (NO in step S92), in step S95, the processor 81 determines whether or not the present state is a state just after the ZR-button 61 has been turned from ON to OFF. As a result of the determination, if the present state is not a state just after the ZR-button 61 has been turned from ON to OFF (NO in step S95), it is determined that a state in which the ZR-button 61 is not pressed has been continuing, and therefore the processor 81 ends the deletion instruction process.

On the other hand, if the present state is a state just after the ZR-button 61 has been turned from ON to OFF (YES in step S95), in step S96, the processor 81 determines whether or not the all-deletion flag 314 is ON. That is, whether a held-down state input has been canceled or a normal ON/OFF operation on the ZR-button has been performed, is determined. As a result of the determination, if the all-deletion flag 314 is ON (YES in step S96), in step S97, the processor 81 sets a “deleting state” as the AO states 374 for all the appearing imitation objects (AOs).

Next, in step S98, for all the in-use indices, the processor 81 sets action parameters for moving them to the follow-up positions. Specifically, for all the in-use indices, the processor 81 sets information indicating “remaining indices” as the index states 334. In addition, the processor 81 sets information indicating the PC 201 in the follow-up target information 335. Next, the processor 81 sets parameters for bringing the in-use indices back to the follow-up positions, as the index movement parameters 333. At this time, the processor 81 also performs setting for the PC 201 to reproduce a deletion-related motion of the PC 201.

Next, in step S99, the processor 81 adds the appearance costs for all the AOs, to the remaining cost.

Next, in step S100, the processor 81 sets OFF for the all-deletion flag 314. At this time, the processor 81 may perform setting for the PC 201 to reproduce a motion dedicated for all deletion. Then, the processor 81 ends the deletion instruction process.

On the other hand, as a result of the determination in step S96, if the all-deletion flag 314 is OFF (NO in step S96), processing for deleting one AO is performed. First, in step S101 in FIG. 48, the processor 81 determines whether or not there is an AO located in front of the PC 201. If there is such an AO (YES in step S101), in step S102, the processor 81 determines the AO as a deletion target AO, and sets a “deleting state” as the AO state 374 for the deletion target AO.

Next, in step S103, the processor 81 performs setting for moving the in-use index put at the deletion target AO to the follow-up position. Specifically, for the in-use index, the processor 81 sets information indicating “remaining index” as the index state 334. The processor 81 sets information indicating the PC 201, for the follow-up target information 335. Further, the processor 81 sets a parameter for moving the in-use index to the follow-up position, as the index movement parameter 333. At this time, the processor 81 also performs setting for the PC 201 to reproduce a motion of deleting the deletion target AO.

Next, in step S104, the processor 81 adds the appearance cost for the deletion target AO to the remaining cost. Then, the processor 81 ends the deletion instruction process.

On the other hand, as a result of the determination in step S101, if there is no AO located in front of the PC 201 (NO in step S101), the processing in steps S102 to S104 is skipped.

[Processing when Transformation Operation has been Performed]

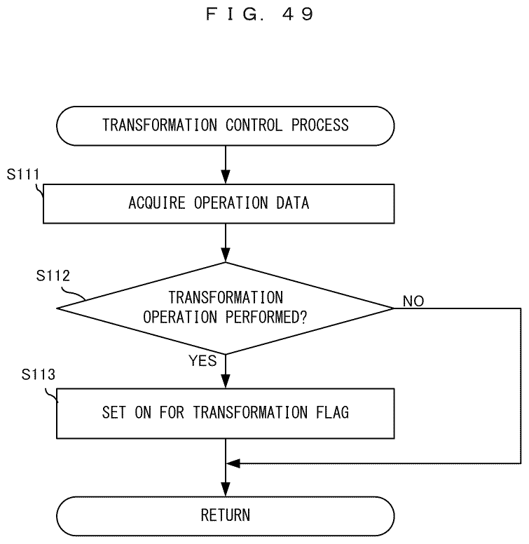

Returning to FIG. 42, next, in step S45, the processor 81 executes a transformation control process. This process is executed when the transformation operation has been performed. FIG. 49 is a flowchart showing the details of this process. In FIG. 49, first, in step S112, the processor 81 determines whether or not the transformation operation has been performed, on the basis of the operation data 309. As a result of the determination, if the transformation operation has been performed (YES in step S112), in step S113, the processor 81 sets ON for the transformation flag 326. At this time, the processor 81 performs setting for reproducing a motion of the PC 201 transforming. Further, the processor 81 performs setting for changing display of the designation box 211 at the upper right on the screen to the attack operation boxes 215 as shown in FIG. 29. On the other hand, if the transformation operation has not been performed (NO in step S112), the above processing is skipped. Then, the processor 81 ends the transformation control process.

### [Quick Designation Control Process]

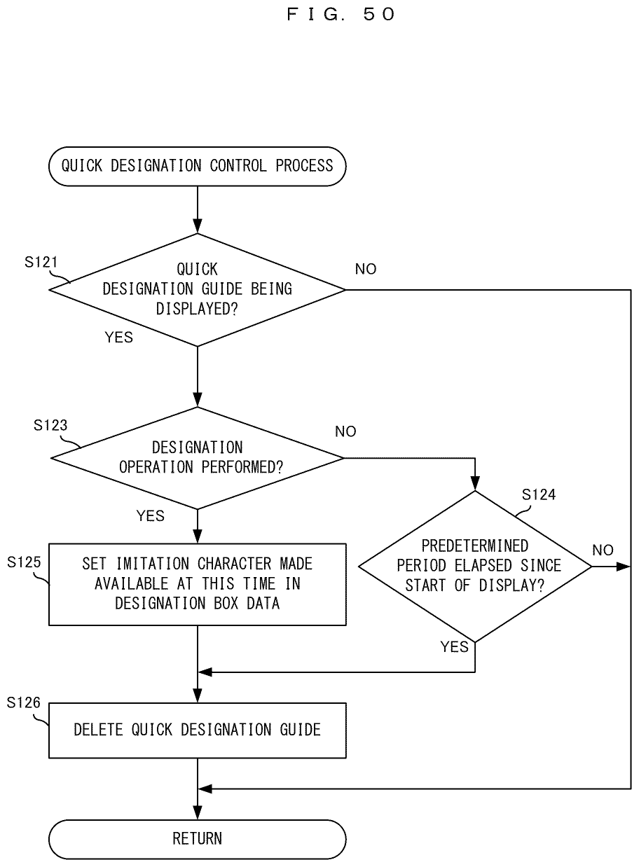

Returning to FIG. 42, next, in step S46, the processor 81 executes a quick designation control process. This process is executed when the A button 53 is pressed while the quick designation guide as shown in FIG. 14 is being displayed. FIG. 50 is a flowchart showing the details of this process. In FIG. 50, first, in step S121, the processor 81 determines whether or not the quick designation guide is being displayed. As a result of the determination, if the quick designation guide is not being displayed (NO in step S121), the processor 81 ends the quick designation control process.

On the other hand, if the quick designation guide is being displayed (YES in step S121), in step S123, the processor 81 determines whether or not a designation operation (pressing the A button 53) has been performed, on the basis of the operation data 309. As a result of the determination, if a designation operation has been performed (YES in step S123), in step S125, the processor 81 sets an ID of an imitation character that has been newly made available at this time, in the designation box data 313. Next, in step S126, the processor 81 deletes the quick designation guide. Then, the processor 81 ends the quick designation control process.

On the other hand, if a designation operation has not been performed (NO in step S213), in step S124, the processor 81 determines whether or not a predetermined period has elapsed since display of the quick designation guide was started. If the predetermined period has elapsed (YES in step S124), the process proceeds to step S126. If the predetermined period has not elapsed yet, the processor 81 ends the quick designation control process.

### [Pause Setting Process]

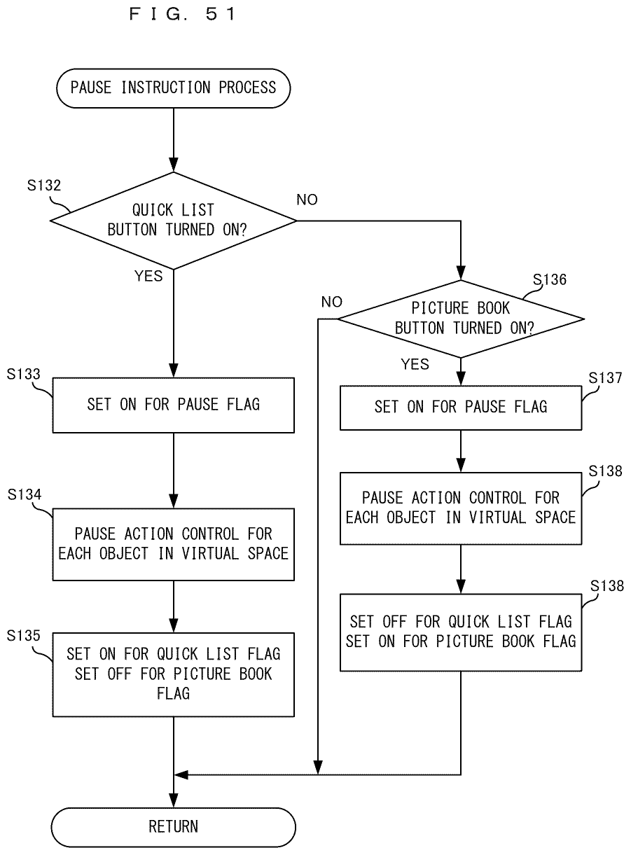

Returning to FIG. 42, next, in step S47, the processor 81 executes a pause setting process. This process is executed when the quick list button (in this example, the right direction button 33) is turned ON or the picture book screen button (in this example, the +button 57) is turned ON. FIG. 51 is a flowchart showing the details of this process. In FIG. 51, first, in step S132, the processor 81 determines whether or not the quick list button is turned ON, on the basis of the operation data 309. As a result of the determination, if the quick list button is turned ON (YES in step S131), in step S133, the processor 81 sets ON for the pause flag 310. Next, in step S134, the processor 81 pauses action control for each object in the virtual space. Thus, progress of the game comes into a paused state. Next, in step S135, the processor 81 sets ON for the quick list flag 315 and sets OFF for the picture book flag 316. Then, the processor 81 ends the pause control process.

On the other hand, if the quick list button is not turned ON (NO in step S132), in step S136, the processor 81 determines whether or not the picture book screen button is turned ON. As a result of the determination, if the picture book screen button is turned ON (YES in step S136), in step S137, the processor 81 sets ON for the pause flag 310. Next, in step S138, the processor 81 pauses action control for each object in the virtual space. Next, in step S139, the processor 81 sets OFF for the quick list flag 315 and sets ON for the picture book flag 316. Then, the processor 81 ends the pause control process. On the other hand, if the picture book screen button is not turned ON (NO in step S136), the processing in step S137 to S139 is skipped and the pause control process is ended.

Returning to FIG. 42, next, in step S48, the processor 81 performs control for reproducing various motions of the PC 201, the support character 202, and the indices 203, on the basis of the above processing result. For example, the processor 81 performs control for reproducing various motions such as a motion of the PC 201 moving, motions of performing the first action, performing the second action, and deleting an AO, a motion of the support character 202 moving, and motions of the indices 203 moving, on the basis of the above processing result. Thus, the processor 81 ends the normal mode process.

[Processing when PC 201 is in Transformed State]

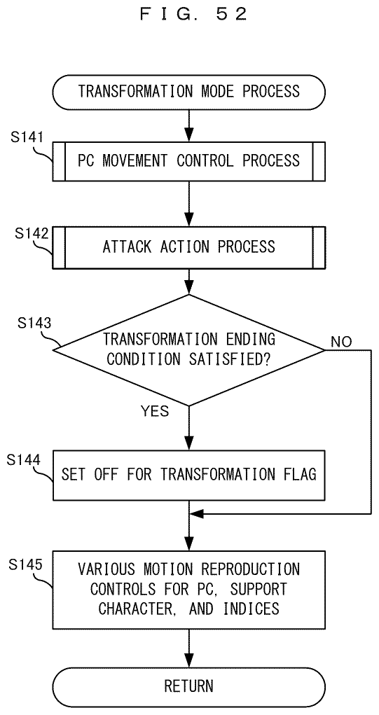

Next, the transformation mode process in step S33 in FIG. 41 will be described. FIG. 52 is a flowchart showing the details of this process. First, in step S141, the processor 81 executes a PC movement control process, as in step S41. That is, the processor 81 executes processing for performing movement control for the PC 201 in a transformed state, the support character 202, and the indices 203, on the basis of a movement operation performed by the user.

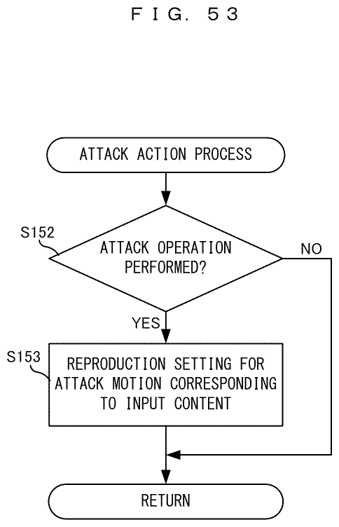

Next, in step S142, the processor 81 executes an attack action process. FIG. 53 is a flowchart showing the details of this process. First, in step S152, the processor 81 determines whether or not an attack operation has been performed, on the basis of the operation data 309. In this example, an attack operation is performed by pressing any of three buttons which are the Y button 56, the X button 55, and the A button 53. As a result of the determination, if an attack operation has been performed (YES in step S152), in step S153, the processor 81 performs setting for reproducing an attack motion corresponding to the pressed button. On the other hand, if an attack operation has not been performed (NO in step S152), the processing in step S153 is skipped. Thus, the attack action process is ended.

Returning to FIG. 52, next, in step S143, the processor 81 determines whether or not a condition for ending the transformed state (transformation ending condition) is satisfied. In this example, when the transformation gauge 213 has become empty or an instruction operation for canceling transformation has been performed by the user, it is determined that the transformation ending condition is satisfied. As a result of the determination, if the transformation ending condition is not satisfied (NO in step S143), the processor 81 decreases the transformation gauge 213 by a predetermined amount and then proceeds to step S145 described later. On the other hand, if the transformation ending condition is satisfied (YES in step S143), in step S144, the processor 81 sets OFF for the transformation flag 326.

Next, in step S145, the processor 81 performs control for reproducing various motions of the PC 201 in a transformed state, the support character 202, the indices 203, and the like, on the basis of the above processing result. Thus, the transformation mode process is ended.

### [AO Control Process]

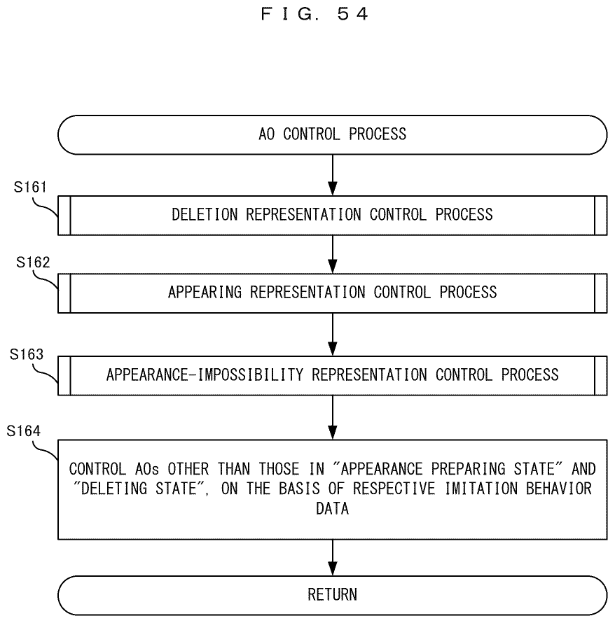

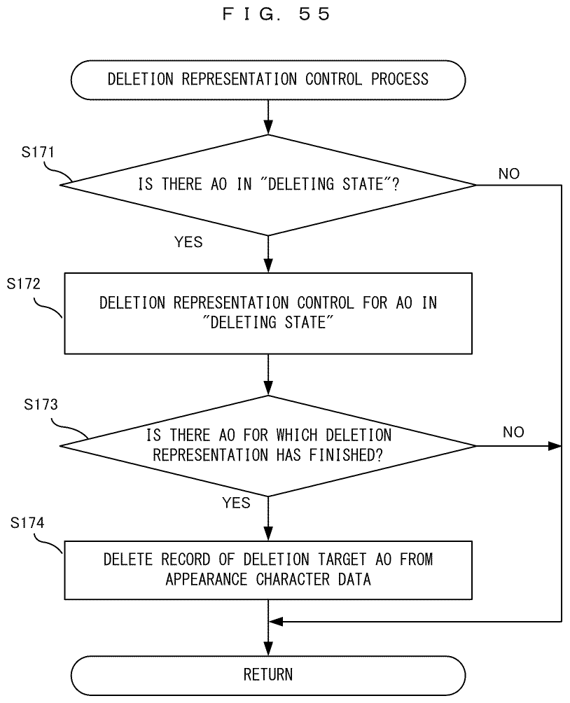

Returning to FIG. 40, next to the PC control process, in step S12, the processor 81 executes an AO control process for controlling an AO. FIG. 54 is a flowchart showing the details of the AO control process. In FIG. 54, first, in step S161, the processor 81 executes a deletion representation control process. FIG. 55 is a flowchart showing the details of this process. In FIG. 55, first, in step S171, the processor 81 determines whether or not there is an AO for which the AO state 374 is “deleting state”. As a result of the determination, if there is no such AO (NO in step S171), the processor 81 ends the deletion representation control process. If there is an AO in a “deleting state” (YES in step S171), in step S172, the processor 81 performs control for causing the AO in a “deleting state” to perform an action for deletion representation. Next, in step S173, the processor 81 determines whether or not there is an AO for which a deletion representation has finished. If there is such an AO (YES in step S173), in step S174, the processor 81 deletes a record for the AO from the appearing object data 308. If there is no AO for which a deletion representation has finished (NO in step S173), the processing in step S174 is skipped. Then, the deletion representation control process is ended.

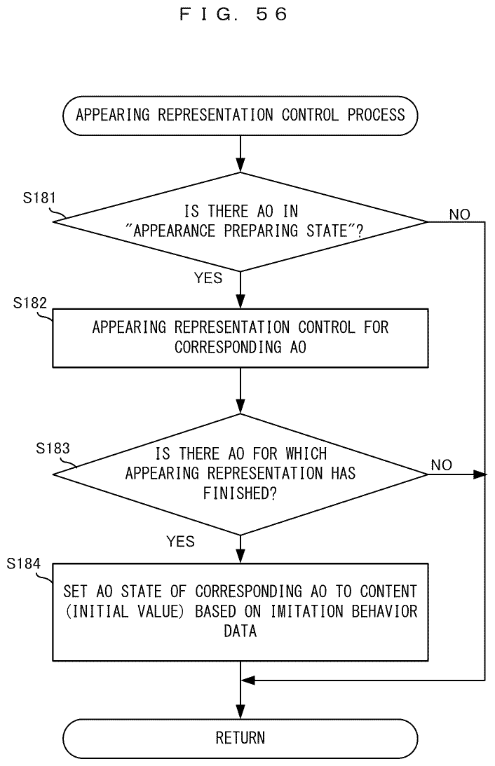

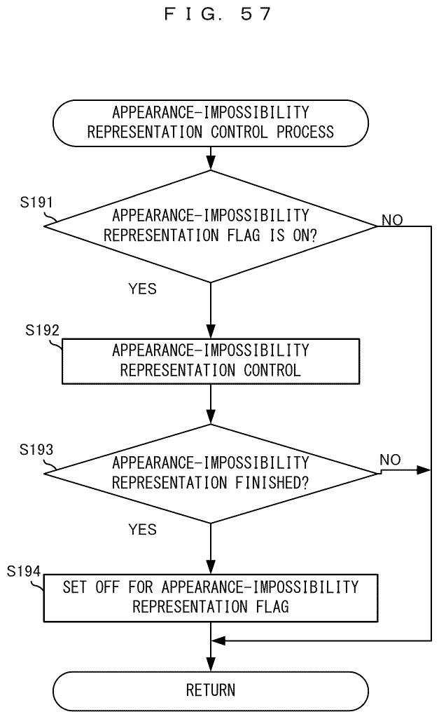

Returning to FIG. 54, next, in step S162, the processor 81 executes an appearing representation control process. FIG. 56 is a flowchart showing the details of this process. In FIG. 56, first, in step S181, the processor 81 determines whether or not there is an AO for which the AO state 374 is “appearance preparing state”. As a result of the determination, if there is no such AO (NO in step S181), the processor 81 ends the appearing representation control process. If there is an AO in an “appearance preparing state” (YES in step S181), in step S182, the processor 81 performs control for an appearing representation in which the AO appears. Next, in step S183, the processor 81 determines whether or not there is an AO for which an appearing representation has finished. If there is such an AO (YES in step S183), in step S184, the processor 81 sets a content based on the corresponding imitation behavior data 363, as the AO state 374 for the AO in the appearing object data 308. For example, an AO state set as an initial value in the imitation behavior data 363 is applied. On the other hand, if there is no AO for which an appearing representation has finished (NO in step S183), the processing in step S184 is skipped. Then, the appearing representation control process is ended.

Returning to FIG. 54, next, in step S163, the processor 81 executes an appearance-impossibility representation control process. FIG. 57 is a flowchart showing the details of this process. In FIG. 57, first, in step S191, the processor 81 determines whether or not the appearance-impossibility representation flag 311 is ON. If the appearance-impossibility representation flag 311 is OFF (NO in step S191), the processor 81 ends the appearance-impossibility representation control process. If the appearance-impossibility representation flag 311 is ON (YES in step S191), in step S192, the processor 81 performs control for an appearance-impossibility representation for reproducing a series of motions in which the imitation object designated by the appearance-impossibility designation data 312 is displayed for a predetermined period and then is deleted immediately. Next, in step S193, the processor 81 determines whether or not the appearance-impossibility representation has finished. If the appearance-impossibility representation has finished (YES in step S193), in step S194, the processor 81 sets OFF for the appearance-impossibility representation flag 311 and deletes the content in the appearance-impossibility designation data 312. On the other hand, if the appearance-impossibility representation has not finished yet (NO in step S193), the processing in step S194 is skipped. Then, the appearing representation control process is ended.

Returning to FIG. 54, next, in step S164, the processor 81 controls AOs for which the AO states 374 are other than “appearance preparing state” and “deleting state”, on the basis of the imitation behavior data 363 corresponding to the respective AOs. In addition, the processor 81 performs movement control for the in-use indices put at the respective AOs so as to follow movements of these AOs. Thus, the AO control process is ended.

### [Control for FO]

Returning to FIG. 40, next, in step S13, the processor 81 controls each FO on the basis of the dynamic behavior data 343. At this time, for a FO which can be a target of the first action and for which the availability flag 365 for the corresponding imitation object of this kind is still OFF, the processor 81 performs setting for displaying the FO with a glittering effect imparted thereto as described above. Therefore, for example, in a case where a plurality of pots 221 that have not been made available yet are displayed at the same time, glittering effects are imparted to all the pots 221. Then, if the first action is performed on any of the pots 221, control is performed so that the pot 221 will not be imparted with a glittering effect after that.

### [Other Relevant Game Process]

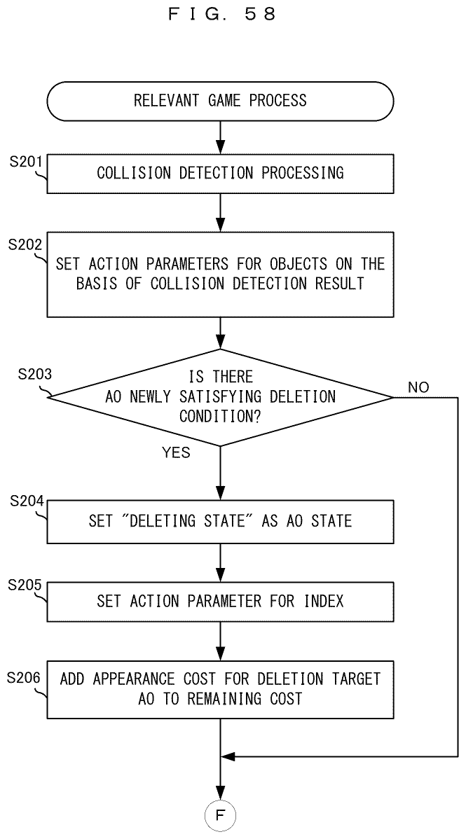

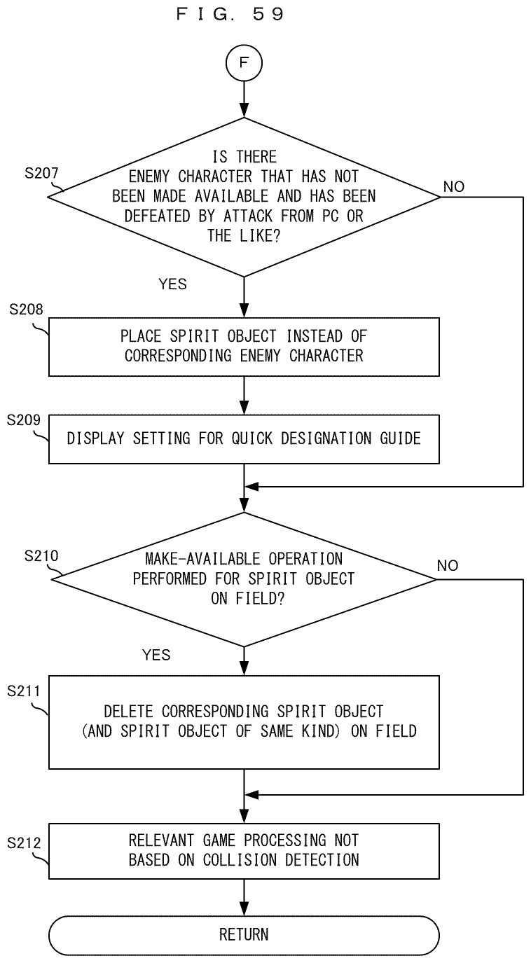

Next, in step S14, the processor 81 executes a relevant game process other than the above processes. FIG. 58 and FIG. 59 are flowcharts showing the details of this process. In FIG. 58, first, in step S201, the processor 81 performs collision detection for each object. Next, in step S202, the processor 81 sets an action parameter for each object on the basis of the collision detection result. For example, such an action parameter that an attacked object is knocked back may be set. In addition, along with this, calculation of various parameters is performed as appropriate, e.g., a predetermined damage value is added or a health is decreased.

Next, in step S203, the processor 81 determines whether or not there is an AO that has newly satisfied a deletion condition for a reason other than a deletion operation by the user as described above. For example, whether or not there is an AO whose health has become 0 by an attack from the enemy character 222, is determined. As a result of the determination, if there is no such AO (NO in step S203), the process proceeds to step S207 described later. On the other hand, if there is such an AO (YES in step S203), in step S204, the processor 81 sets a “deleting state” as the AO state 374 so that the AO becomes a deletion target AO. Next, in step S205, the processor 81 sets an action parameter for moving the index 203 put at the AO to the follow-up position. Next, in step S206, the processor 81 adds the appearance cost for the deletion target AO to the remaining cost.

Next, in step S207 in FIG. 59, the processor 81 determines whether or not there is an enemy character 222 that has not been made available yet and has been defeated by an attack from the PC 201 or an AO as a result of the processing based on collision detection as described above. As a result of the determination, if there is no such enemy character 222 (NO in step S207), the process proceeds to step S210 described later. If there is such an enemy character 222 (YES in step S207), in step S208, the processor 81 updates the content of the FO data 306 so that the spirit object 223 as shown in FIG. 17 is placed instead of the enemy character 222. Thus, the spirit object 223 is displayed. At this time, the spirit object 223 is displayed with a glittering effect imparted as described above.

Next, in step S209, the processor 81 performs setting for displaying the quick designation guide as shown in FIG. 14 for a predetermined period.

Next, in step S210, the processor 81 determines whether or not the make-available operation has been performed for the spirit object 223 present on the field. That is, whether or not the first action control process has been executed for the spirit object 223, is determined. As a result of the determination, if the make-available operation has not been performed for the spirit object 223 (NO in step S210), the process proceeds to step S212 described later. On the other hand, if the make-available operation has been performed (YES in step S210), in step S211, the processor 81 deletes a record for the corresponding spirit object 223 from the FO data 306. Thus, the spirit object 223 is deleted from the field. At this time, in a case where a plurality of spirit objects 223 of the same kind are displayed, control is performed so as to delete all of them.

Next, in step S212, the processor 81 executes relevant game processing not based on the above collision detection, as appropriate. For example, in a case where the PC 201 has reached an entrance object of a cave, the PC 201 is moved to an area corresponding to “inside of the cave”, and parameter setting for the virtual camera is performed so that the area of “inside of the cave” is displayed as a side view image.

Thus, the relevant game process in step S14 is ended.

Returning to FIG. 40, the field play process is thus ended.

Returning to FIG. 39, next to the field play process, in step S5, the processor 81 generates and outputs a game image in which a processing result of the above field play process, or a processing result of a quick list process or a picture book process described later, is reflected. Next, in step S6, the processor 81 determines whether or not a game ending condition is satisfied. If the game ending condition is not satisfied (NO in step S6), the process returns to step S2, so as to be repeated. If the game ending condition is satisfied, the processor 81 ends the game processing according to the exemplary embodiment.

Next, processing in a case where the pause flag 310 is ON as a result of the determination in step S3 (YES in step S3) will be described. In this case, in step S7, the processor 81 determines whether or not the quick list flag 315 is ON. As a result of the determination, if the quick list flag 315 is ON (YES in step S7), in step S8, the processor 81 executes a quick list process. On the other hand, if the quick list flag 315 is OFF (NO in step S7), in step S9, the processor 81 executes a picture book process. Hereinafter, the details of these processes will be described.

### [Process for Quick List Screen]

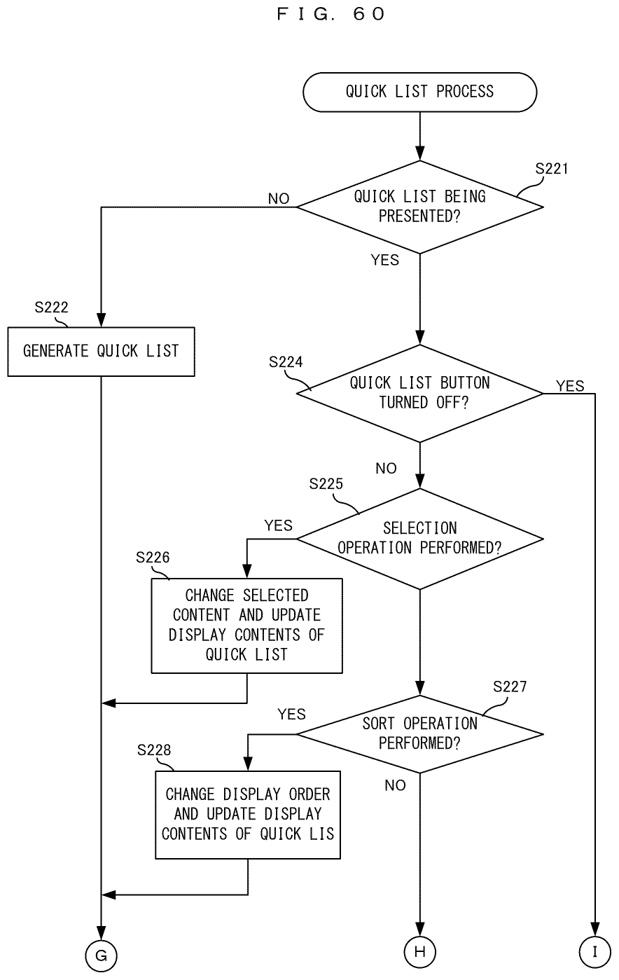

First, the quick list process will be described. FIG. 60 is a flowchart showing the details of the quick list process. In FIG. 60, first, in step S221, the processor 81 determines whether or not the quick list 251 is being presented. That is, whether or not the present state is a state just after the quick list button (right direction button 33) is turned ON (a state in which the quick list 251 has not been generated yet), is determined. As a result of the determination, if the quick list 251 has not been presented yet (NO in step S221), in step S222, the processor 81 generates the quick list 251 (and the sort designation 252) on the basis of the quick list data 317. Thus, in the processing in step S5, the quick list screen as described above is outputted. Then, the processor 81 ends the quick list process.

Returning to FIG. 60, as a result of the determination in step S221, if the quick list 251 has already been presented (YES in step S221), next, in step S224, the processor 81 determines whether or not an input of the quick list button is turned OFF, on the basis of the operation data 309. As a result of the determination, if an input of the quick list button is not turned OFF (NO in step S224), next, in step S225, the processor 81 determines whether or not a selection operation has been performed. The selection operation is an operation of moving the cursor 253 by the right stick 52. As a result of the determination, if the selection operation has been performed (YES in step S225), in step S226, the processor 81 moves the cursor 253 in accordance with the operation content, to change the selected content at present. In addition, as necessary, the display contents of the quick list 251 are scrolled in the horizontal direction so that the display contents are changed. Then, the process proceeds to step S230.

On the other hand, if a selection operation has not been performed (NO in step S225), next, in step S227, the processor 81 determines whether or not a sort operation has been performed. In the exemplary embodiment, a sort operation is performed by pressing the Y button 56. As a result of the determination, if a sort operation has been performed (YES in step S227), in step S228, the processor 81 selects an arrangement order to be applied at this time, from the preset arrangement orders. Then, the processor 81 applies the selected arrangement order to the quick list data 317. Then, the processor 81 changes the contents to be displayed as the quick list 251, on the basis of the quick list data 317 for which the arrangement order has been changed. As described above, every time the user presses the Y button 56, the arrangement order to be applied is selected in a predetermined order. Therefore, every time the Y button 56 is pressed, the contents to be displayed as the quick list 251 (arrangement order) can also be changed. Then, the process proceeds to step S230.

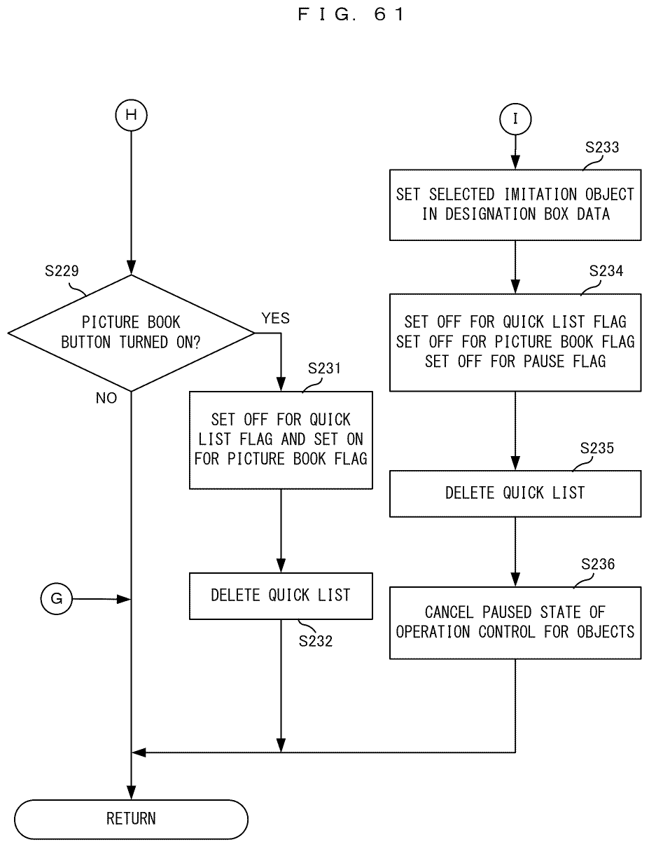

On the other hand, as a result of the determination in step S227, if a sort operation has not been performed (NO in step S227), in step S229 in FIG. 61, the processor 81 determines whether or not the picture book screen button (+button 57) is turned ON. As a result of the determination, if the picture book screen button is not turned ON (NO in step S229), the process proceeds to step S230.

On the other hand, as a result of the determination in step S229, if the picture book screen button is turned ON (YES in step S229), in step S231, the processor 81 sets OFF for the quick list flag 315 and sets ON for the picture book flag 316. Next, in step S232, the processor 81 deletes the quick list 251. Then, the processor 81 ends the quick list process.

Next, a case where an input of the quick list button is turned OFF as a result of the determination in step S224 (YES in step S224) will be described. In this case, processing for definitely determining the selected content is performed. First, in step S233 in FIG. 61, the processor 81 sets, in the designation box data 313, an imitation object selected at present in the quick list 251. Next, in step S234, the processor 81 sets OFF for the quick list flag 315, the picture book flag 316, and the pause flag 310. Next, in step S235, the processor 81 deletes the quick list 251. Next, in step S236, the processor 81 cancels the state in which action control for each object is paused. Then, the processor 81 ends the quick list process.

### [Process for Picture Book Screen]

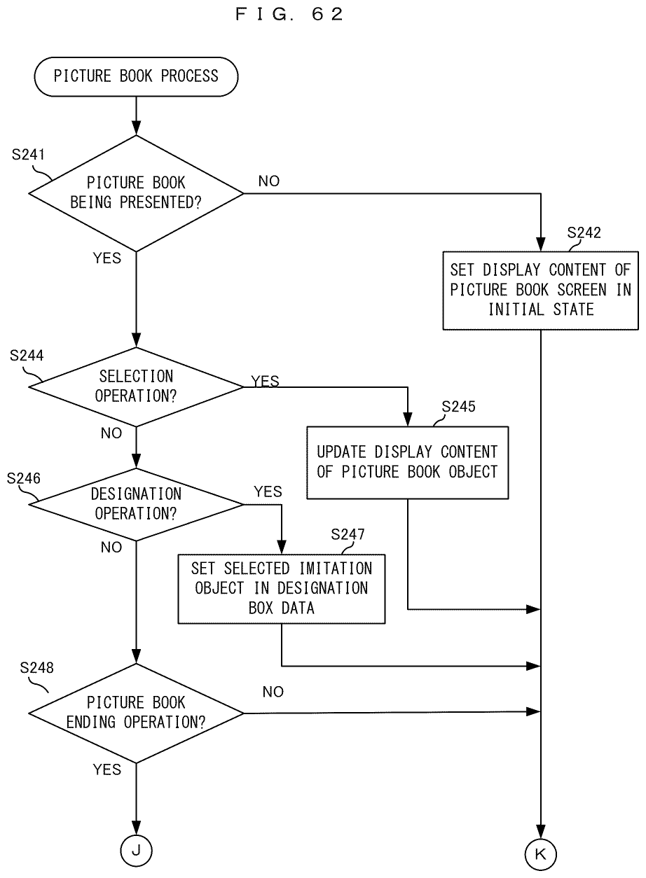

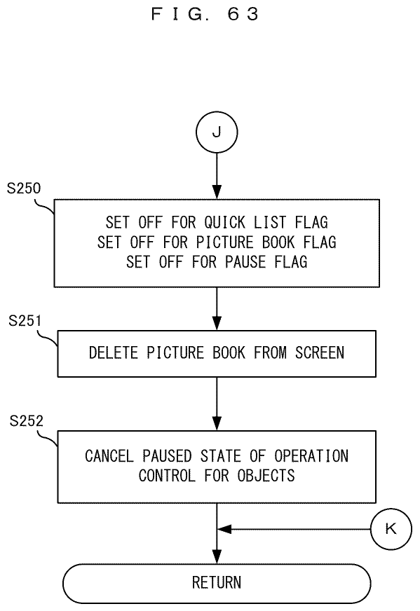

Next, the picture book process will be described. FIG. 62 and FIG. 63 are flowcharts showing the details of the picture book process. In FIG. 62, first, in step S241, the processor 81 determines whether or not the picture book is being presented. That is, whether or not the present state is a state just after the picture book screen button is turned ON is determined. As a result of the determination, if the picture book has not been presented yet (NO in step S241), in step S242, the processor 81 sets the display content of the picture book screen in an initial state, on the basis of the picture book data 318. Specifically, the processor 81 sets a two-dimensional array list of imitation objects available at present, as the display content in the list area 261. In addition, the processor 81 places the cursor 264 at a predetermined position, and sets an explanation text and the like for an imitation object present at the predetermined position, as the display content in the detailed information area 262. Thus, in the processing in step S5, the picture book screen as described above is outputted. Then, the processor 81 ends the picture book process.

On the other hand, as a result of the determination in step S241, if the picture book has already been presented (YES in step S241), in step S244, the processor 81 determines whether or not a selection operation has been performed, on the basis of the operation data 309. That is, whether or not an operation of moving the cursor 264 by the right stick 52 has been performed is determined. As a result of the determination, if a selection operation has been performed (YES in step S244), in step S245, the processor 81 moves the cursor 264 in accordance with the operation content, and changes the selected content at present in the list area 261. Along with this, the processor 81 changes the display content in the detailed information area 262. In addition, in a case where the scroll bar 263 has been operated, the processor 81 also performs control for scrolling the list area 261 in the vertical direction and changing the display content. Then, the processor 81 ends the picture book process.

On the other hand, if a selection operation has not been performed (NO in step S244), in step S246, the processor 81 determines whether or not a designation operation (pressing the A button 53) for an imitation object to the designation box 211 has been performed. As a result of the determination, if a designation operation has been performed (YES in step S246), in step S247, the processor 81 sets the imitation object selected at present, in the designation box data 313. Then, the processor 81 ends the picture book process.

On the other hand, if a designation operation has not been performed (NO in step S246), in step S248, the processor 81 determines whether or not a picture book ending operation (pressing the B button 54) has been performed. As a result of the determination, if a picture book ending operation has not been performed (NO in step S248), the processor 81 ends the picture book process. If a picture book ending operation has been performed (YES in step S248), in step S250 in FIG. 63, the processor 81 sets OFF for the quick list flag 315, the picture book flag 316, and the pause flag 310. Next, in step S251, the processor 81 deletes the picture book from the screen. Next, in step S252, the processor 81 cancels the state in which operation control for each object is paused. Then, the processor 81 ends the picture book process.

Thus, the detailed description of the game processing according to the exemplary embodiment has finished.

As described above, in the exemplary embodiment, it is possible to provide such a game that allows a user to proceed with the game using a plurality of various imitation objects. In particular, in a case where the PC 201 in a normal state is a character having no attack ability, it is possible to provide such a way of enjoying the game that the user causes imitation objects to battle in place of the PC 201 while proceeding with the game.

The outer appearances and the behaviors of the imitation objects are partially the same as those of the dynamic objects. Then, for example, regarding an enemy character, the user can directly view the behavior of the enemy character by battling the enemy character. Therefore, while normally proceeding with the game, the user can predict or grasp what action the imitation object corresponding to the enemy character will perform, to a certain extent, in advance. Thus, convenience for the user can be improved. In addition, since the display manner of the imitation object is made different from that of the dynamic object, the user can easily distinguish both objects even when the dynamic object and the imitation object are present at the same time.

An appearance cost for causing each imitation object to appear is set, and a representation in which the index 203 is moved is performed when the imitation object appears. Thus, cost change can be shown to the user in a visually understandable manner. In addition, control is performed so that, above the imitation object that has appeared, the index 203 follows the imitation object. Thus, the index 203 is always put at the imitation object that has appeared, and this makes the display manner different from that of the dynamic object. Therefore, the user can distinguish the dynamic object and the imitation object also by focusing on presence/absence of the index 203.

The indices 203 corresponding to the remaining cost are moved while following the PC 201, whereby information about the remaining cost is displayed near the PC 201. Alternatively, it is conceivable that information indicating the remaining cost is displayed at an upper right corner of the screen, for example. However, the viewpoint of the user during play is expected to mainly focus on an area around the PC 201. Therefore, when such information is displayed near the PC 201, the user can grasp the cost usage state more easily than in a case where the user has to direct the line of sight to a screen corner.

### [Modifications]

In the above exemplary embodiment, the appearance cost and the remaining cost are represented by the number of the indices 203. In this regard, in another exemplary embodiment, the remaining cost and the like may be represented by a “size” of a predetermined object corresponding to the cost, for example. For example, the quantity of the remaining cost may be represented by changing the “size” of the support character 202.

Regarding the quick list screen, the above description has shown such a control example that the quick list screen is “ended” once when an input of the right direction button 33 is turned OFF. In this regard, in another exemplary embodiment, the quick list may be “minimized” in size, instead of being “ended”. That is, control may be performed such that, while the display contents of the quick list and the like are kept, the quick list is displayed at a corner of the screen while being made into an icon or the like.

On the quick list screen, such a control example that the designation box 211 is set when an input of the right direction button 33 is turned OFF has been shown. In another exemplary embodiment, for example, an imitation object may be set in the designation box 211 every time the cursor 253 is transferred. In this case, the display content of the designation box 211 can change every time the cursor 253 is transferred.

The game may be configured to allow an instruction operation so that an appearing imitation object performs a predetermined action. For example, in a case where the imitation enemy is appearing, the user may be allowed to designate the enemy character 222 as an attack target of the imitation enemy. For example, the game may be configured to allow the user to perform a lock-on operation of designating a predetermined enemy character 222, and an imitation object may be controlled to perform such a behavior as to preferentially attack the enemy that the user has locked on.

In the above exemplary embodiment, the case where the game processing is executed by a single main body apparatus 2 has been described. The main body apparatus 2 may include a plurality of storage units and processors. Then, the game processing may be executed while being shared among the storage units and the processors. The game processing may be executed in a distributed system composed of a plurality of information processing apparatuses including a server.

While the present disclosure has been described herein, it is to be understood that the above description is, in all aspects, merely an illustrative example, and is not intended to limit the scope thereof. It is to be understood that various modifications and variations can be made without deviating from the scope of the present disclosure.

What is claimed is:

1. One or more computer-readable non-transitory storage media having stored therein a game program configured to cause at least one processor of an information processing apparatus to:
control a player character in a virtual space on the basis of an operation input;
automatically control a plurality of kinds of dynamic objects which are placed on a field in the virtual space, on the basis of behaviors set for the respective kinds;
for imitation objects each of which an outer appearance and a set behavior are at least partially the same as those of at least one of the plurality of kinds of the dynamic objects and each of which a display manner is different from that of the at least one dynamic object, cause the player character to perform a predetermined action and cause a designated imitation object designated among a plurality of kinds of the imitation objects to appear on the field, in accordance with a first instruction based on an operation input; and
automatically control the imitation object with a set behavior, on the field.

2. The one or more computer-readable non-transitory storage media having stored therein the game program according to claim 1, wherein
a cost required for appearance is set for each of the imitation objects, and
the game program causes the processor to place a set cost index indicating the cost set for the imitation object, at a position in conjunction with the imitation object in the virtual space.

3. The one or more computer-readable non-transitory storage media having stored therein the game program according to claim 2, wherein
a plurality of the imitation objects are allowed to be placed on the field at the same time, as long as a total cost of the costs set for all the imitation objects on the field does not exceed an upper limit cost set for the player character, and
the game program further causes the processor to:
place a remaining cost index indicating a remaining cost obtained by subtracting the total cost from the upper limit cost, at a position in conjunction with the player character in the virtual space; and
in a case where the designated imitation object has appeared on the field in accordance with the first instruction, move and place at least a part of the remaining cost index as the set cost index set for the designated imitation object, thus reducing the remaining cost index.

4. The one or more computer-readable non-transitory storage media having stored therein the game program according to claim 3, the game program further causing the processor to:
in a case where a second instruction based on an operation input has been performed, delete a deletion target imitation object designated among the imitation objects on the field; and
move the set cost index placed in conjunction with the deletion target imitation object, so that the set cost index becomes a part of the remaining cost index, thus increasing the remaining cost index.

5. The one or more computer-readable non-transitory storage media having stored therein the game program according to claim 4, the game program further causing the processor to:
in a case where the first instruction has been performed and the cost set for the designated imitation object exceeds the remaining cost, delete the imitation object that appeared earliest on the field and cause the designated imitation object to appear on the field.

6. The one or more computer-readable non-transitory storage media having stored therein the game program according to claim 5, the game program further causing the processor to:
in a case where the first instruction has been performed and a position on the field at which the designated imitation object is to appear is a position at which the imitation object is not allowed to be placed, perform control so as to, without deleting the imitation object on the field, display the designated imitation object for a predetermined period and then delete the designated imitation object.

7. The one or more computer-readable non-transitory storage media having stored therein the game program according to claim 1, the game program further causing the processor to:
present a first list that allows selection from the plurality of kinds of imitation objects in accordance with a third instruction based on an operation input;
while the first list is being presented, stop behaviors of objects in the virtual space including at least the player character, the dynamic objects, and the imitation objects; and
in accordance with a fourth instruction based on an operation input performed while the first list is being presented, select and designate any of the plurality of kinds of imitation objects as the designated imitation object, end presentation of the first list, and restart the behaviors of the objects in the virtual space.

8. The one or more computer-readable non-transitory storage media having stored therein the game program according to claim 7, wherein
the third instruction is an operation of turning on an input to a first operation key,
the fourth instruction is an operation of turning off the input to the first operation key, and
the game program causes the processor to:
while the input to the first operation key is on, present the first list, and change the imitation object to be selected on the first list, in accordance with a fifth instruction based on an operation input; and
designate the imitation object selected when the fourth instruction has been performed, as the designated imitation object.

9. The one or more computer-readable non-transitory storage media having stored therein the game program according to claim 8, the game program further causing the processor to:
while the first list is being presented, in a case where a sixth instruction based on an operation input has been performed, present a second list instead of the first list; and
while the second list is being presented, in accordance with a seventh instruction based on an operation input, change the imitation object to be selected on the second list, and in accordance with an eighth instruction based on an operation input, designate the selected imitation object as the designated imitation object and end presentation of the second list, wherein
the first list is a list in which icons of the plurality of kinds of imitation objects are arranged in one row, and
the second list is a list in which icons of the plurality of kinds of imitation objects are arranged two-dimensionally and with which a text regarding the selected imitation object is displayed.

10. The one or more computer-readable non-transitory storage media having stored therein the game program according to claim 1, the game program further causing the processor to:
shift the player character into a first mode in accordance with a ninth instruction based on an operation input; and
in the first mode,
cause the player character to perform an attack action instead of causing the imitation object to appear, in accordance with the first instruction,
automatically control the imitation object placed on the field, with the set behavior, and
cancel the first mode in accordance with a tenth instruction based on an operation input.

11. The one or more computer-readable non-transitory storage media having stored therein the game program according to claim 10, the game program further causing the processor to:
in the first mode,
change a first parameter as time elapses, and
in a case where the first parameter satisfies a predetermined condition, cancel the first mode.

12. The one or more computer-readable non-transitory storage media having stored therein the game program according to claim 1, the game program further causing the processor to:
in a case where the player character has performed a predetermined action to the dynamic object on the field, add the imitation object of a kind corresponding to the dynamic object, to the plurality of kinds of the imitation objects.

13. The one or more computer-readable non-transitory storage media having stored therein the game program according to claim 1, wherein
the field includes at least a top view field which is a field where a virtual camera is set on a top view, and a side view field which is a field where a virtual camera is set on a side view, and
behaviors set for the dynamic objects and the imitation objects are behaviors in the top view field and the side view field.

14. A game system comprising at least one processor configured to:
control a player character in a virtual space on the basis of an operation input;
automatically control a plurality of kinds of dynamic objects which are placed on a field in the virtual space, on the basis of behaviors set for the respective kinds;
for imitation objects each of which an outer appearance and a set behavior are at least partially the same as those of at least one of the plurality of kinds of the dynamic objects and each of which a display manner is different from that of the at least one dynamic object, cause the player character to perform a predetermined action and cause a designated imitation object designated among a plurality of kinds of the imitation objects to appear on the field, in accordance with a first instruction based on an operation input; and
automatically control the imitation object with a set behavior, on the field.

15. The game system according to claim 14, wherein
a cost required for appearance is set for each of the imitation objects, and the game system causes the processor to place a set cost index indicating the cost set for the imitation object, at a position in conjunction with the imitation object in the virtual space.

16. The game system according to claim 14, the processor being further configured to:
present a first list that allows selection from the plurality of kinds of imitation objects in accordance with a third instruction based on an operation input;
while the first list is being presented, stop behaviors of objects in the virtual space including at least the player character, the dynamic objects, and the imitation objects; and
in accordance with a fourth instruction based on an operation input performed while the first list is being presented, select and designate any of the plurality of kinds of imitation objects as the designated imitation object, end presentation of the first list, and restart the behaviors of the objects in the virtual space.

17. The game system according to claim 14, the processor being further configured to:
shift the player character into a first mode in accordance with a ninth instruction based on an operation input; and
in the first mode,
cause the player character to perform an attack action instead of causing the imitation object to appear, in accordance with the first instruction,
automatically control the imitation object placed on the field, with the set behavior, and
cancel the first mode in accordance with a tenth instruction based on an operation input.

18. A game apparatus comprising at least one processor configured to:
control a player character in a virtual space on the basis of an operation input;
automatically control a plurality of kinds of dynamic objects which are placed on a field in the virtual space, on the basis of behaviors set for the respective kinds;
for imitation objects each of which an outer appearance and a set behavior are at least partially the same as those of at least one of the plurality of kinds of the dynamic objects and each of which a display manner is different from that of the at least one dynamic object, cause the player character to perform a predetermined action and cause a designated imitation object designated among a plurality of kinds of the imitation objects to appear on the field, in accordance with a first instruction based on an operation input; and
automatically control the imitation object with a set behavior, on the field.

19. A game processing method for causing a processor of an information processing apparatus to:
control a player character in a virtual space on the basis of an operation input;
automatically control a plurality of kinds of dynamic objects which are placed on a field in the virtual space, on the basis of behaviors set for the respective kinds;
for imitation objects each of which an outer appearance and a set behavior are at least partially the same as those of at least one of the plurality of kinds of the dynamic objects and each of which a display manner is different from that of the at least one dynamic object, cause the player character to perform a predetermined action and cause a designated imitation object designated among a plurality of kinds of the imitation objects to appear on the field, in accordance with a first instruction based on an operation input; and
automatically control the imitation object with a set behavior, on the field.

20. The game processing method according to claim 19, wherein
a cost required for appearance is set for each of the imitation objects, and
the game processing method causes the processor to place a set cost index indicating the cost set for the imitation object, at a position in conjunction with the imitation object in the virtual space.

21. The game processing method according to claim 20, wherein
a plurality of the imitation objects are allowed to be placed on the field at the same time, as long as a total cost of the costs set for all the imitation objects on the field does not exceed an upper limit cost set for the player character, and
the game processing method further causes the processor to:
place a remaining cost index indicating a remaining cost obtained by subtracting the total cost from the upper limit cost, at a position in conjunction with the player character in the virtual space; and
in a case where the designated imitation object has appeared on the field in accordance with the first instruction, move and place at least a part of the remaining cost index as the set cost index set for the designated imitation object, thus reducing the remaining cost index.

22. The game processing method according to claim 21, further causing the processor to:
in a case where a second instruction based on an operation input has been performed, delete a deletion target imitation object designated among the imitation objects on the field; and
move the set cost index placed in conjunction with the deletion target imitation object, so that the set cost index becomes a part of the remaining cost index, thus increasing the remaining cost index.

23. The game processing method according to claim 22, further causing the processor to:
in a case where the first instruction has been performed and the cost set for the designated imitation object exceeds the remaining cost, delete the imitation object that appeared earliest on the field and cause the designated imitation object to appear on the field.

24. The game processing method according to claim 23, further causing the processor to:
in a case where the first instruction has been performed and a position on the field at which the designated imitation object is to appear is a position at which the imitation object is not allowed to be placed, perform control so as to, without deleting the imitation object on the field, display the designated imitation object for a predetermined period and then delete the designated imitation object.

25. The game processing method according to claim 19, further causing the processor to:
present a first list that allows selection from the plurality of kinds of imitation objects in accordance with a third instruction based on an operation input;
while the first list is being presented, stop behaviors of objects in the virtual space including at least the player character, the dynamic objects, and the imitation objects; and
in accordance with a fourth instruction based on an operation input performed while the first list is being presented, select and designate any of the plurality of kinds of imitation objects as the designated imitation object, end presentation of the first list, and restart the behaviors of the objects in the virtual space.

26. The game processing method according to claim 25, wherein
the third instruction is an operation of turning on an input to a first operation key, the fourth instruction is an operation of turning off the input to the first operation key, and
the game processing method causes the processor to:
while the input to the first operation key is on, present the first list, and change the imitation object to be selected on the first list, in accordance with a fifth instruction based on an operation input; and
designate the imitation object selected when the fourth instruction has been performed, as the designated imitation object.

27. The game processing method according to claim 26, further causing the processor to:
while the first list is being presented, in a case where a sixth instruction based on an operation input has been performed, present a second list instead of the first list; and
while the second list is being presented, in accordance with a seventh instruction based on an operation input, change the imitation object to be selected on the second list, and in accordance with an eighth instruction based on an operation input, designate the selected imitation object as the designated imitation object and end presentation of the second list, wherein
the first list is a list in which icons of the plurality of kinds of imitation objects are arranged in one row, and
the second list is a list in which icons of the plurality of kinds of imitation objects are arranged two-dimensionally and with which a text regarding the selected imitation object is displayed.

28. The game processing method according to claim 19, further causing the processor to:
shift the player character into a first mode in accordance with a ninth instruction based on an operation input; and
in the first mode,
cause the player character to perform an attack action instead of causing the imitation object to appear, in accordance with the first instruction,
automatically control the imitation object placed on the field, with the set behavior, and
cancel the first mode in accordance with a tenth instruction based on an operation input.

29. The game processing method according to claim 28, further causing the processor to:
in the first mode,
change a first parameter as time elapses, and
in a case where the first parameter satisfies a predetermined condition, cancel the first mode.

30. The game processing method according to claim 19, further causing the processor to:
in a case where the player character has performed a predetermined action to the dynamic object on the field, add the imitation object of a kind corresponding to the dynamic object, to the plurality of kinds of the imitation objects.

31. The game processing method according to claim 19, wherein
the field includes at least a top view field which is a field where a virtual camera is set on a top view, and a side view field which is a field where a virtual camera is set on a side view, and
behaviors set for the dynamic objects and the imitation objects are behaviors in the top view field and the side view field.
